(19) United States
(12) Patent Application Publication
(10) Pub. No.: US 2024/0086039 A1
(43) Pub. Date: Mar. 14, 2024

(54) ORDER ASSISTANCE APPARATUS, SYSTEM, AND METHOD, AND COMPUTER-READABLE MEDIUM

(71) Applicant: NEC Corporation, Minato-ku, Tokyo (JP)

(72) Inventors: Tetsuya Fuyuno, Tokyo (JP); Kumiko Takatsuka, Tokyo (JP); Mayumi Itou, Tokyo (JP); Yosuke Minowa, Tokyo (JP); Mari Tanaka, Tokyo (JP)

(73) Assignee: NEC Corporation, Minato-ku, Tokyo (JP)

(21) Appl. No.: 18/275,156

(22) PCT Filed: Sep. 6, 2021
(86) PCT No.: PCT/JP2021/032681

§ 371 Date: Jul. 31, 2023

(51) Int. Cl. G06F 3/0484; G06Q 30/0601

(52) U.S. Cl. CPC G06F 3/0484; G06Q 30/0641

(57) ABSTRACT

An order assistance apparatus includes: a display control unit configured to display sales information that has accepted the selecting operation with an addition of the number of orders corresponding to the number of times of the selecting operations in question; and a determination unit configured to determine whether or not the number of orders in question is equal to or greater than an upper limit value, in which when the number of orders is smaller than the upper limit value, the display control unit updates a display of the number of orders added to the sales information that has accepted a selecting operation by a value obtained by adding a number corresponding to the single selecting operation to the number of orders in question, and clears the number of orders in question when the number of orders is equal to or greater than the upper limit value.

### TECHNICAL FIELD

The present invention relates to an order assistance apparatus, system, and method, and a computer-readable medium.

### BACKGROUND ART

Patent Literature 1 discloses technology related to an information processing apparatus for listing information on a plurality of images and accepting selection using a portable terminal. Such information processing apparatus in Patent Literature 1 extracts, for each image recognized from captured video data, corresponding additional data and displays the additional data on each image.

### CITATION LIST

### Patent Literature

Patent Literature 1: International Patent Publication No. WO 2014/017392

### SUMMARY OF INVENTION

### Technical Problem

In recent years, there has been a growing demand for simpler operations on e-commerce order screens. However, the above-described technology has such problem that a cancelling operations for selected sales information during ordering operations using a touch-sensitive panel of a tablet terminal and the like is complicated.

In view of the above-described issue, it is an object of the present disclosure to provide an order assistance apparatus, system, method, and program, which are configured to facilitate cancelling operations for selected sales information on an order screen.

### Solution to Problem

An order assistance apparatus according to a first aspect of the present disclosure includes:
display control means configured to display sales information that has accepted the selecting operation from among the plurality of pieces of sales information displayed on the screen with the addition of the number of orders corresponding to the number of times of the selecting operations in question; and
determining means configured to determine whether or not the number of orders in question is equal to or greater than an upper limit value when the selecting operation for the sales information displayed with the addition of the number of orders is accepted,
and
in which the display control means:
updates the display of the number of orders added to the sales information that has accepted the selecting operation by a value obtained by adding the number of orders in question to a number corresponding to a single selecting operation when the number of orders is smaller than the upper limit value, and
clears the number of orders in question when the number of orders is equal to or greater than the upper limit value.

An order assistance system according to a second aspect of the present disclosure includes:
a user terminal configured to display a plurality of pieces of sales information on a screen and accept a selecting operation for any of the plurality of sales information from a user; and
an order assistance apparatus connected to the user terminal, in which
the order assistance apparatus includes:
display control means configured to display sales information that has accepted the selecting operation from among the plurality of pieces of sales information displayed on the screen with the addition of the number of orders corresponding to the number of times of the selecting operations in question;
determining means configured to determine whether or not the number of orders in question is equal to or greater than an upper limit value when the selecting operation for the sales information displayed with the addition of the number of orders is accepted, and in which
the display control means:
updates the display of the number of orders added to the sales information that has accepted the selecting operation by a value obtained by adding the number of orders in question to a number corresponding to a single selecting operation when the number of orders is smaller than the upper limit value; and
clears the number of orders in question when the number of orders is equal to or greater than the upper limit value.

An order assistance method according to a third aspect of the present disclosure includes a method, the method causing a computer to:
display sales information that has accepted the selecting operation from among the plurality of pieces of sales information displayed on the screen with the addition of the number of orders corresponding to the number of times of the selecting operations in question;
determine whether or not the number of orders in question is equal to or greater than an upper limit value when the selecting operation for the sales information displayed with the addition of the number of orders is accepted,
update the display of the number of orders added to the sales information that has accepted the selecting operation by a value obtained by adding the number of orders in question to a number corresponding to a single selecting operation when the number of orders is smaller than the upper limit value, and
clear the number of orders in question when the number of orders is equal to or greater than the upper limit value.

An order assistance program according to a fourth aspect of the present disclosure, the program causing a computer to execute:
processing for displaying sales information that has accepted the selecting operation from among the plurality of pieces of sales information displayed on the screen with the addition of the number of orders corresponding to the number of times of the selecting operations in question;
processing for determining whether or not the number of orders in question is equal to or greater than an upper limit value when the selecting operation for the sales information displayed with the addition of the number of orders is accepted;
processing for updating the display of the number of orders added to the sales information that has accepted the selecting operation by a value obtained by adding a number corresponding to a single selecting operation to the number of orders in question when the number of orders is smaller than the upper limit value; and
processing for clearing the number of orders in question when the number of orders is equal to or greater than the upper limit value.

### Advantageous Effects of Invention

According to the present disclosure, it is possible to provide order assistance apparatus, system, method, and program, which are configured to facilitate cancelling operations for selected sales information on an order screen.

### BRIEF DESCRIPTION OF DRAWINGS

FIG. 1 is a block diagram illustrating a configuration of a sales assistance apparatus according to a first example embodiment;

FIG. 2 is a flowchart showing a flow of a sales assistance method according to the first example embodiment;

FIG. 3 is a block diagram illustrating a configuration of a sales assistance system according to a second example embodiment;

FIG. 4 is a block diagram illustrating a configuration of a user terminal according to the second example embodiment;

FIG. 5 is a block diagram illustrating a configuration of an authentication apparatus according to the second example embodiment;

FIG. 6 is a flowchart showing a flow of facial information registration processing by the authentication apparatus according to the second example embodiment;

FIG. 7 is a flowchart showing a flow of facial authentication processing by the authentication apparatus according to the second example embodiment;

FIG. 8 is a block diagram illustrating a configuration of a sales assistance apparatus according to the second example embodiment;

FIG. 9 is a drawing illustrating an example of an order screen according to the second example embodiment;

FIG. 10 is a flowchart showing a flow of an order assistance processing according to the second example embodiment;

FIG. 11 is a drawing illustrating an example showing a state in which an item has been selected according to the second example embodiment;

FIG. 12 is a drawing illustrating an example showing a state in which an item has been selected to the upper limit value according to the second example embodiment;

FIG. 13 is a drawing of an example illustrating a state in which the selection of the item has been canceled according to the second example embodiment;

FIG. 14 is a flowchart showing a flow of upper limit value update processing according to the second example embodiment;

FIG. 15 is a drawing illustrating an example of an upper limit value update notification screen according to the second example embodiment; and

FIG. 16 is a sequence diagram showing a flow of keyword search processing according to the second example embodiment.

### EXAMPLE EMBODIMENTS

Hereinafter, example embodiments of this disclosure will be described in detail with reference to the drawings. In each drawing, the same or corresponding elements are marked with the same signs, and duplicate explanations are omitted where necessary for clarity of explanation.

### First Example Embodiment

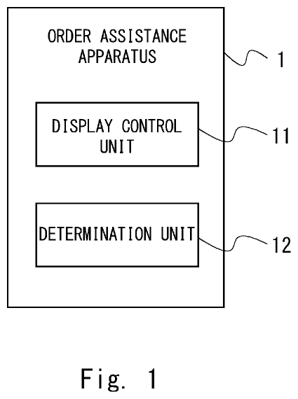

FIG. 1 is a block diagram illustrating a configuration of an order assistance apparatus 1 according to a first example embodiment. The order assistance apparatus 1 is an information processing apparatus configured to assist in the ordering operations for sales information, which is carried by users through a touch-sensitive panel on a tablet terminal and the like. As used herein, the term “sales information” refers to information assisting sales of items or services, which may also be referred to as information that encourages the purchase of items or services. The sales information is information for receiving orders for purchase by users. The sales information is information that provide overviews of items or services being sold, including, for example, images, descriptive texts (name, origin, etc.), prices, and the like. In addition, the order assistance apparatus 1 is assumed to be connected to a user terminal provided with the above-described touch-sensitive panel via a communication network (not illustrated, hereinafter also referred to simply as ‘network’) or a predetermined wireless communication. Note that the network can be wired or wireless, and any types of communication protocol can be used. The touch-sensitive panel is one example of an input/output apparatus which serves as both a screen (display apparatus) of the user terminal (information terminal) and an operation accepting unit (input apparatus). The user terminal in question displays one or more pieces of sales information on the screen and accepts input operations from the user for a designated area within the screen. The designated area includes selection areas for the sales information and an order confirmation area for the selected sales information. Input operations for the designated area within the screen may be, for example, touch operations with the user's finger and the like to the touch-sensitive panel, or may be input operations through other input apparatuses (for example, mouse and keyboard). The input operations include sales information selecting operation and order confirming operation for the selected sales information. Upon reception of an input operation, the user terminal transmits information relating to the designated area corresponding to the input operation to the order assistance apparatus 1 via the network. For example, upon reception of the selecting operation for specific sales information, the user terminal transmits a notification indicating that the sales information in question has been selected to the order assistance apparatus 1. Therefore, at the moment when the selecting operation is accepted, the order is assumed not to be confirmed.

The order assistance apparatus 1 includes a display control unit 11 and a determination unit 12. The display control unit 11 displays the sales information that has accepted the selecting operation from among the plurality of pieces of sales information displayed on the screen with the addition of the number of orders corresponding to the number of times of the selecting operations in question. As used herein, the term “screen” refers to the screen of the above-described user terminal. For example, the display control unit 11 displays the sales information that has accepted the selecting operation and the number of orders on the screen of the user terminal. When selecting operation for the sales information displayed with the addition of the number of orders is accepted, the determination unit 12 determines whether or not the number of orders in question is equal to or greater than the upper limit value.

When the number of orders, which is determined by the determination unit 12, is smaller than the upper limit value, the display control unit 11 updates the display of the number of orders added to the sales information that has accepted the selecting operation by a value obtained by adding a number corresponding to one selecting operation to the number of orders. In contrast, when the number of orders determined by the determination unit 12 is equal to or greater than the upper limit value, the display control unit 11 clears the number of orders in question. As used herein the term “clear the number of orders” may mean that the display control unit 11 deletes the display of the number of orders added to the sales information that has accepted the selecting operation from the screen. Alternatively, the term “clear the number of orders” may mean that the display control unit 11 updates the display of the number of orders added to the sales information that has accepted the selecting operation to 0.

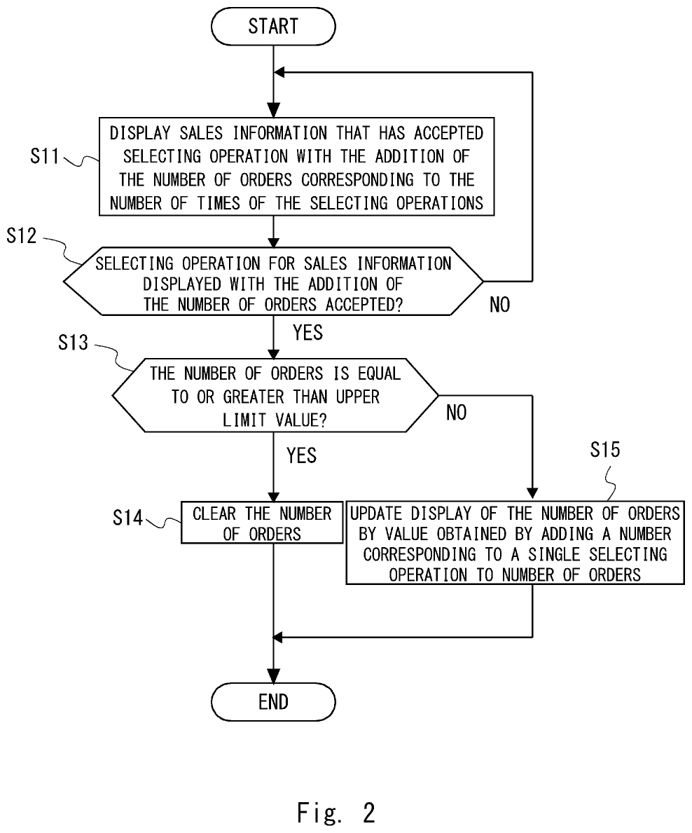

FIG. 2 is a flowchart showing a flow of an order assistance method according to the first example embodiment. The assumption is that a plurality of pieces of sales information are already displayed on the screen of the user terminal. The user shall have performed the selecting operation on a specific sales information from among the plurality of pieces of sales information displayed on the screen. At this time, the user terminal transmits a notification indicating that a selecting operation has been performed for a specific sales information to the order assistance apparatus 1. Accordingly, the display control unit 11 of the order assistance apparatus 1 displays the sales information that has accepted the selecting operation with the addition of the number of orders corresponding to the number of times of the selecting operations (S11). In other words, the user terminal displays the sales information that has accepted the selecting operation on the screen with the addition of a value of the number of orders.

Subsequently, the user shall have performed the selecting operation on a specific sales information displayed on the screen with the addition of the number of orders. At this time, the user terminal transmits a notification indicating that a selecting operation has been performed for the sales information with the addition of the number of orders to the order assistance apparatus 1. The determination unit 12 of the order assistance apparatus 1 determines whether or not the selecting operation for the sales information displayed with the addition of the number of orders has been accepted (S12).

When the sales information that has accepted the selecting operation is not added with the number of orders (NO in Step S12), the display control unit 11 executes Step S11 again. In contrast, when sales information that has accepted the selecting operation is added with the number of orders (YES in Step S12), the determination unit 12 executes Step S13. In other words, when the selecting operation for sales information displayed with the addition of the number of orders is accepted, the determination unit 12 of the order assistance apparatus 1 determines whether or not the number of orders in question is equal to or greater than the upper limit value (S13). The term upper limit value used herein may vary depending on the sales information or the user.

When the number of orders is smaller than the upper limit value (NO in Step S13), the display control unit 11 updates the display of the number of orders added to the sales information that has accepted the selecting operation by a value obtained by adding a number corresponding to a single selecting operation to the number of orders in question (S15). For example, the display control unit 11 notifies the number of orders after the addition to the user terminal. Therefore, the user terminal updates and displays a value of the number of orders added to the sales information that has accepted the selecting operation on the screen.

In contrast, when the number of orders is equal to or greater than the upper limit value (YES in Step S13), the display control unit 11 clears the number of orders (S14). For example, the display control unit 11 notifies an instruction to delete the number of orders to the user terminal. In this case, the user terminal deletes the number of orders added to the sales information that has accepted the selecting operation from the screen. Alternatively, the display control unit 11 notifies the user terminal of the number of orders as 0. In this case, the user terminal updates the value of the number of orders added to the sales information that has accepted the selecting operation to 0 and displays it on the screen.

In this manner, in the present example embodiment, by repeating the selecting operation for a specific sales information in a state in which the order is not confirmed, the user can add the number of orders (desired number of orders, expected number of orders) for the sales information in question. When the number of orders of the specific sales information is equal to or greater than the upper limit value when the user performs the selecting operation for sales information in question, the number of orders for the sales information in question is cleared. In other words, the order of the selected specific sales information is canceled. In other words, the user can perform a cancelling operation by the selecting operation which is the same as the selecting operation for adding the number of orders to the specific sales information. In other words, the present example embodiment can be described as a commonization of the operation for adding the number of orders and the operation for clearing the number of orders. Therefore, the user does not need to perform a different operation for clearing the number of orders from the operation for adding the number of orders. For example, the user does not need to locate the area for clearing the number of orders or to remember another operation for clearing the number of orders. Therefore, the present example embodiment can facilitate the cancelling operation for the selected sales information on the order screen.

In addition, even when the user performs the selecting operation for adding the number of orders repeatedly, the number of orders is automatically cleared when the number of times of the selecting operations exceeds a predetermined value. This deters users from unintentionally placing excessive orders.

Note that the order assistance apparatus 1 includes a processor, a memory, and a storage apparatus as configurations not illustrated. In addition, the storage apparatus in question stores computer program in which processing of the order assistance method according to the present example embodiment is implemented. The processor in question causes the computer program to be read from the storage apparatus to the memory to execute the computer program in question. Accordingly, the processor implements functions of the display control unit 11 and the determination unit 12.

Alternatively, each of components of the order assistance apparatus 1 may be implemented by dedicated hardware. In addition, some, or all of each component of each apparatus may be implemented by general-purpose or dedicated circuits (circuitry), processors or the like, or a combination thereof. They may be configured by a single chip or may be configured by a plurality of chips connected via a bus. Some or all of each component of each apparatus may be implemented by a combination of the above-described circuits and the like and a program. Furthermore, Central Processing Unit (CPU), Graphics Processing Unit (GPU), Field-Programmable Gate Array (FPGA), a quantum processor (quantum computer control chip), and the like can be used as the processor.

When some or all of each component of the order assistance apparatus 1 is implemented by a plurality of information processing apparatuses, the circuitry, and the like, the plurality of information processing apparatuses, the circuitry and the like may be centrally located or distributed. For example, the information processing apparatus and the circuitry and the like may be implemented each in a form of being connected via a communication network such as a client server system, a cloud computing system, and the like. In addition, the function of the order assistance apparatus 1 may be provided in a form of SaaS (Software as a Service).

### Second Example Embodiment

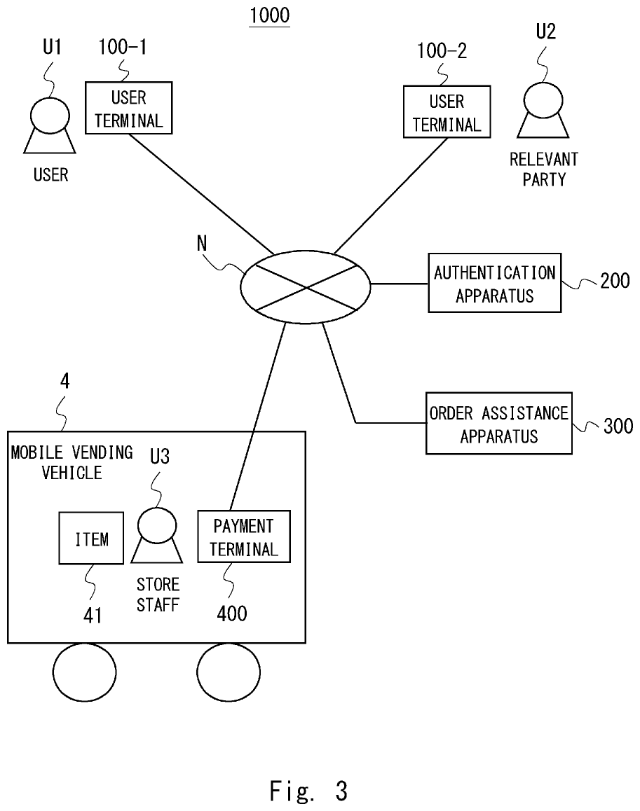

A second example embodiment is a specific example of the above-described first example embodiment. FIG. 3 is a block diagram illustrating a configuration of an order assistance system 1000 according to the second example embodiment. The order assistance system 1000 is an information system for assisting ordering operations for sales information, which is carried by a user U1 through a touch-sensitive panel on a user terminal 100-1.

The order assistance system 1000 includes user terminals 100-1 and 100-2, an authentication apparatus 200, an order assistance apparatus 300, and a payment terminal 400. The user terminals 100-1 and 100-2, the authentication apparatus 200, the order assistance apparatus 300, and the payment terminal 400 are each connected via a network N. As used herein the network N is a wired or wireless communication line, for example, the internet.

The user terminal 100-1 is an information terminal used by a user U1 and is installed, for example, in the residence of the user U1. As used herein the user U1 is not limited to those who are capable of making payment decisions and completing a transaction independently and may be, for example, the elderly living alone. The user terminal 100-1 is operated by the user U1 and transmits and receives data to and from the order assistance apparatus 300 via the network N through wireless communication. The user terminal 100-1 may display a character resembling an animal or robot using the installed software and may cause the character to function as a user interface, serving as an interactive partner for user U1. In this case, the user terminal 100-1 analyzes content control information from the order assistance apparatus 300, displays the character, and performs voice output or text display as dialogue lines for the character. Furthermore, the user terminal 100-1 picks up the user U1's speech and transmits the picked-up voice information or the voice recognition results to the order assistance apparatus 300. This allows the user U1 to engage in dialogue (conversation) with the character displayed on the user terminal 100-1.

The user terminal 100-2 is an information terminal possessed and used by a relevant party U2. As used herein the relevant party U2 is a relevant party such as a relative, guardian, and the like of the user U1. The user terminal 100-2 is operated by the relevant party U2 and transmits and receives data to and from the order assistance apparatus 300 via the network N through wireless communication. The user terminal 100-2 may interact with the order assistance apparatus 300 through a general-purpose Social Network Service (SNS) application for exchanging text data. For example, when the SNS application is a message application, it is possible to exchange messages between the above-described character as a user and the relevant party U2 to implement the exchange of messages with the user U1 through the character.

Hereinafter, the user terminals 100-1 and 100-2 may be referred to simply as “user terminal 100” when no particular distinction is necessary. The user terminal 100 is an information processing apparatus that can be a mobile phone terminal, smartphone, tablet terminal, a Personal Computer (PC) equipped with or connected to a camera, and the like.

Note that the term “identity authentication information” in the following description refers to information used for authentication of the identity verification (such as identity authentication, identity verification processing, and the like) and is information that uniquely identifies (distinguishes) an individual. In the example embodiment, the identity authentication is described as facial authentication, which is one example of biometric authentication, and the identity authentication information (identity identification information) is described as facial feature information, which is one example of biometric information. However, other technologies using captured images of a person can be applied for biometric authentication and the biometric information. For example, biometric information may include data (feature values) calculated from physical characteristics unique to the individual, such as fingerprints, voice prints, veins, retinas, irises of the eyes, and palm patterns (patterns). Other identity authentication may be applied instead of biometric authentication, and other identity authentication information may be used as biometric information. For example, the identity authentication information includes, but is not limited to, user IDs, combinations of IDs and passwords, the contents of identification cards such as my number cards or driver's license (identification number, etc. or password), electronic certificates, and code information. Note that the code information may be a two-dimensional code, for example, QR code (registered trademark).

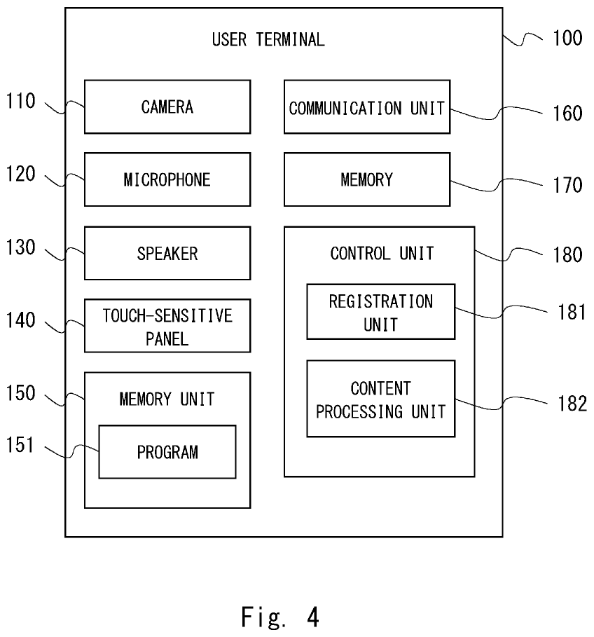

FIG. 4 is a block diagram illustrating a configuration of a user terminal 100 according to the second example embodiment. The user terminal 100 includes a camera 110, a microphone 120, a speaker 130, a touch-sensitive panel 140, a memory unit 150, a communication unit 160, a memory 170, and a control unit 180. The camera 110 is an image capturing apparatus configured to capture images in response to control by the control unit 180. The microphone 120 is a sound pickup apparatus configured to picks up a voice of speech output by the user U1 and the like. The speaker 130 is an apparatus configured to output sounds in response to control by the control unit 180. The touch-sensitive panel 140 includes a display apparatus (display unit) such as a screen and an input apparatus. The memory unit 150 is one example of a storage apparatus including a nonvolatile memory such as a flash memory or Solid State Drive (SSD). The memory unit 150 stores a program 151 for implementing each functions of the user terminal 100. The program 151 is a computer program that implements user information registration processing and processing including software that functions as a user interface. The communication unit 160 is a communication interface with the network N. The memory 170 is a volatile storage apparatus such as Random Access Memory (RAM) and the like, which is a storage area for temporarily retaining information when the control unit 180 is operating. The control unit 180 is a processor configured to control the hardware of the user terminal 100. The control unit 180 reads the program 151 from the memory unit 150 to the memory 170 and executes it. This makes the control unit 180 to implement functions of the registration unit 181 and the content processing unit 182.

The registration unit 181 performs the pre-registration processing for the user information. For example, when pre-registering the user information of the user U1, the registration unit 181 accepts facial images or identification information (identity authentication information) and personal information of the user U1 input by the user U1. The registration unit 181 transmits the accepted facial images and the personal information as well as a registration request for the user information including the terminal information of the user terminal 100-1 to the order assistance apparatus 300 via the network N. Note that the registration unit 181 may include, instead of the facial images, other identity authentication information in a registration request for registration. The registration unit 161 may receive a user ID issued from the order assistance apparatus 300 via the network N when registering the user information and register the user ID in the memory unit 150 as an identity authentication information. In addition, when pre-registering the user information of the relevant party U2, the registration unit 181 accepts facial images or identification information (identity authentication information) and personal information of the relevant party U2 input by the relevant party U2. The registration unit 181 transmits the accepted facial images and the personal information as well as a registration request for the user information including the terminal information of the user terminal 100-2 to the order assistance apparatus 300 via the network N. The registration unit 181 may also include the user ID issued when registering the user information of the relevant party U2 in the registration request of the user U1 as the identification information of the relevant party of the user U1. Note that the user information of the user U1 and the relevant party U2 may be registered together.

Note that the facial images of the user U1 and the like may be those captured by the camera 110 or those acquired from an external apparatus. The personal information may also include voice information or voice recognition results in which the speech of the user U1 or the like is picked up. The personal information shall include payment information such as bank account information, credit card information, and the like. The terminal information is information that serves as the destination of notifications to the user terminal 100.

The content processing unit 182 analyzes content control information from the order assistance apparatus 300, displays a character on the touch-sensitive panel 140 to provide the above-described user interface. In response to an order screen display operation or a display request voice from the user U1, the content processing unit 182 transmits an order screen display request to the order assistance apparatus 300, receives order screen information including one or more sales information, and display the order screen on the touch-sensitive panel 140. In this case, the order screen shall at least include selection areas corresponding to the sales information and an order confirmation area. The order screen display request may also include an identity authentication information of the user and terminal information of the user terminal 100. Note that the content processing unit 182 may display sales information via the character.

When the input operations for the respective areas displayed on the order screen from the user U1 is accepted, the content processing unit 182 transmits information of the area corresponding to the input operation to the order assistance apparatus 300. The content processing unit 182 receives screen update information according to the input operation from the order assistance apparatus 300, and updates the order screen.

For example, the content processing unit 182 accepts the selecting operation with respect to the selection areas, and transmits the notification indicating the selecting operation for a specific sales information has been done to the order assistance apparatus 300. The content processing unit 182 receives instructions to display the display information indicating “selected” and the number of orders, or instructions to delete the display information and the number of orders from the order assistance apparatus 300, and updates the display contents on the order screen according to the instructions.

The content processing unit 182 also accepts a page switching operation, an order confirming operation, a purchase termination operation, and the like as the input operation, transmits information corresponding to each operation to the order assistance apparatus 300, accepts instructions corresponding to each operation from the order assistance apparatus 300, and updates the display contents on the order screen according to the instructions.

Referring back to FIG. 3, description will be continued.

The authentication apparatus 200 is an information processing apparatus configured to manage facial feature information of users. Furthermore, upon reception of a facial authentication request received from external sources, the authentication apparatus 200 matches facial images or facial feature information contained in the request in question with the facial feature information of each user, and transmits back the collated result (authentication result) to the requester.

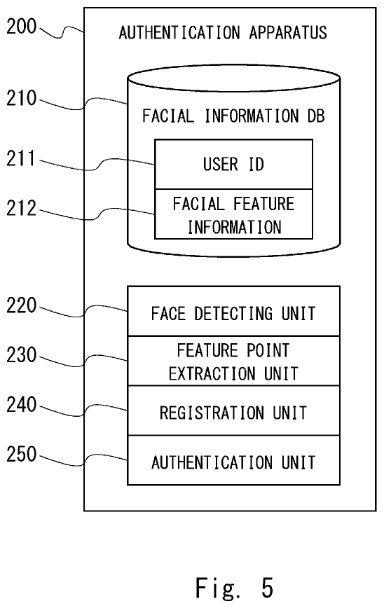

FIG. 5 is a block diagram illustrating a configuration of an authentication apparatus 200 according to the second example embodiment. The authentication apparatus 200 includes a facial information Data Base (DB) 210, a face detecting unit 220, a feature point extraction unit 230, a registration unit 240, and an authentication unit 250. The facial information DB 210 stores user IDs 211 associated with facial feature information 212 of the user IDs in question. The facial feature information 212 is a set of feature points extracted from facial images. Note that the authentication apparatus 200 may delete the facial feature information 212 in the facial feature DB 210 upon request from the user and the like corresponding to the facial feature information 212. Alternatively, the authentication apparatus 200 may delete the facial feature information 212 after a certain period of time has elapsed from registration.

The face detecting unit 220 detects facial areas included in the registered images for registering facial information and outputs the facial areas to the feature point extraction unit 230. The feature point extraction unit 230 extracts feature points from the facial areas detected by the face detecting unit 220, and outputs facial feature information to the registration unit 240. The feature point extraction unit 230 also extracts feature points included in the facial images received from the order assistance apparatus 300 and the like, and outputs the facial feature information to the authentication unit 250.

The registration unit 240 newly issues a user ID 211 when registering the facial feature information. The registration unit 240 registers the issued user ID 211 associated with facial feature information 212 extracted from the registered images in the facial information DB 210. The authentication unit 250 performs facial authentication using the facial feature information 212. Specifically, the authentication unit 250 matches facial feature information extracted from facial images with facial feature information 212 in facial information DB 210. When the matching is successful, the authentication unit 250 identifies the user ID 211 in correspondence to the matched facial feature information 212. The authentication unit 250 returns the presence or absence of matches in the facial feature information to the requester as a facial authentication result. The presence or absence of matches in the facial feature information corresponds to the success or failure of the authentication. Note that the term “facial feature information matches” (matched) shall refer to a case where the similarity score is equal to or greater than a threshold value. Moreover, in the case of successful facial authentication, the facial authentication result shall include an identified user ID.

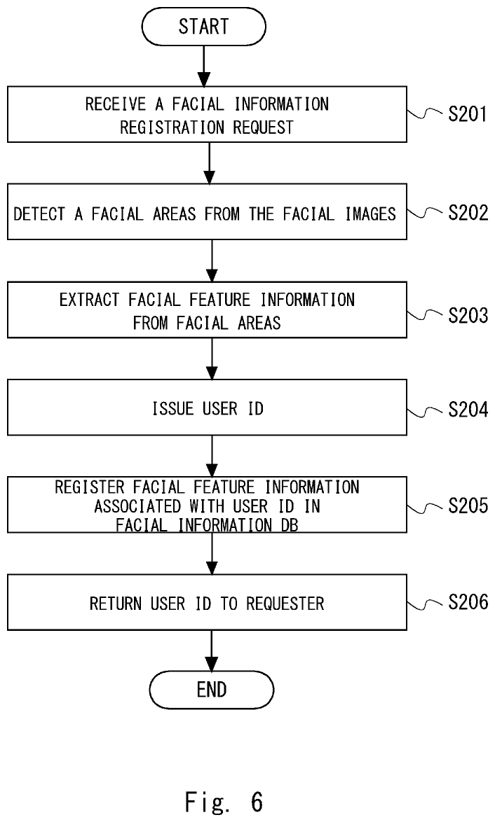

FIG. 6 is a flowchart showing a flow of facial information registration processing by the authentication apparatus according to the second example embodiment. The information registration terminal (not illustrated) captures images the body of a user including the face, and transmits a facial information registration request including the captured images (registered images) to the authentication apparatus 200 via the network N. The information registration terminal is an information processing apparatus such as a personal computer, smartphone, tablet terminal, and the like. For example, the information registration terminal may be the user terminal 100 and the like. The information registration terminal here shall be the order assistance apparatus 300 that has accepted a user information registration request from the user terminal 100 and the like.

First, the authentication apparatus 200 receives a facial information registration request (S201). For example, the authentication apparatus 200 receives the facial information registration request from the order assistance apparatus 300 via the network N. Next, the face detecting unit 220 detects a facial areas from the facial images included in the facial information registration request (S202). The feature point extraction unit 230 extracts feature points (facial feature information) from the facial areas detected in Step S202 (S203). The registration unit 240 issues a user ID 211 (S204). The registration unit 240 registers the extracted facial feature information 212 associated with the issued user ID 211 in the facial information DB 210 (S205). Subsequently, the registration unit 240 returns the issued user ID 211 to the requester (information registration terminal, for example, the order assistance apparatus 300) (S206).

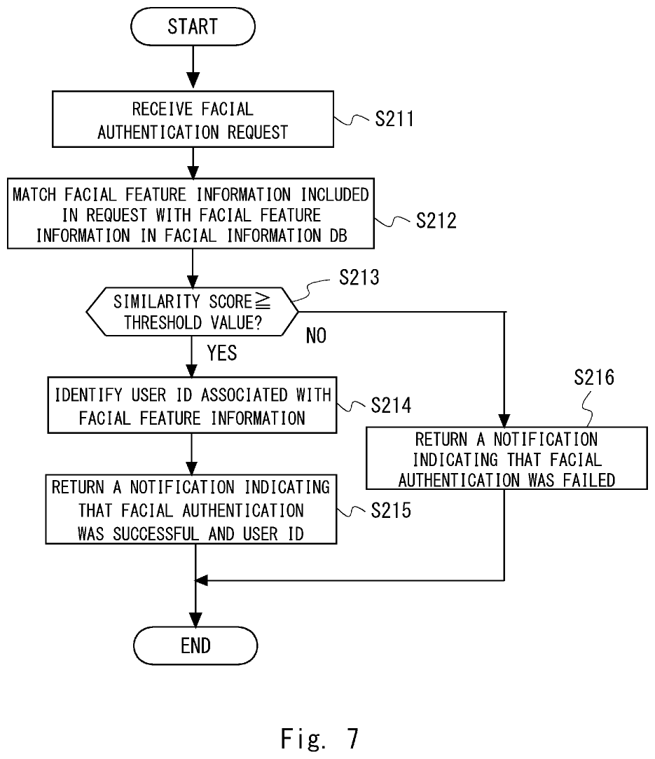

FIG. 7 is a flowchart showing a flow of facial authentication processing by the authentication apparatus according to the second example embodiment. First, the authentication apparatus 200 receives the facial authentication request from the order assistance apparatus 300 via the network N (S211). Note that the authentication apparatus 200 may receive the facial authentication request from the user terminal 100 and the like. Next, the authentication apparatus 200 extracts facial feature information from the facial images included in the facial authentication request in the same manner as Steps S202 and S203 described above. The authentication unit 250 of the authentication apparatus 200 matches the facial feature information extracted from the facial images included in the facial authentication request with the facial feature information 212 of the facial information DB 210 (S212) and calculates the similarity score. The authentication unit 250 determines whether or not the similarity score is equal to the threshold value or greater (S213). When the facial feature information matches, that is, when the similarity score of the facial feature information is equal to or greater than the threshold value, the authentication unit 250 identifies the user ID 211 in correspondence to the facial feature information 212 (S214). The authentication unit 250 returns the facial authentication result including the notification indicating that the facial authentication was successful and the identified User ID 211 to the order assistance apparatus 300 via the network N (S215). When the similarity score is lower than the threshold value in Step S213, the authentication unit 250 returns the facial authentication result including the notification indicating that the facial authentication was failed to the order assistance apparatus 300 via the network N (S216).

Referring back to FIG. 3, description will be continued.

A mobile vending vehicle 4 is a vehicle with store staff U3 on board, which moves to one or more locations to conduct sales for delivering items such as an item 41 at the destination after relocation. The mobile vending vehicle 4 is assumed to be loaded with the item 41 and the like, which is at least part of the sales information accepted as orders by the order assistance apparatus 300. The mobile vending vehicle 4 is assumed to be equipped with the payment terminal 400. The payment terminal 400 may be the information terminal possessed and operated by the store staff U3. The payment terminal 400 receives an instruction to reserve the item 41 ordered by the user U1 from the order assistance apparatus 300 via the network N and displays the instruction in question. The store staff U3 reserves the item 41 according to the instruction and delivers the items 41 when the user U1 comes to the mobile vending vehicle 4. Note that when the store staff U3 receives an instruction to reserve the item 41 before the departure of the mobile vending vehicle 4, the store staff U3 may proceed to load the item 41 on the mobile vending vehicle 4 and then depart with the mobile vending vehicle 4.

Referring back to FIG. 3, description will be continued.

The order assistance apparatus 300 is one example of the above-described order assistance apparatus 1. The order assistance apparatus 300 is an information processing apparatus configured to perform user registration processing, order assistance processing, upper limit value update processing, keyword search processing, and the like (order assistance method according to the second example embodiment). The order assistance apparatus 300 may be redundant across a plurality of servers and each functional block may be implemented by a plurality of computers.

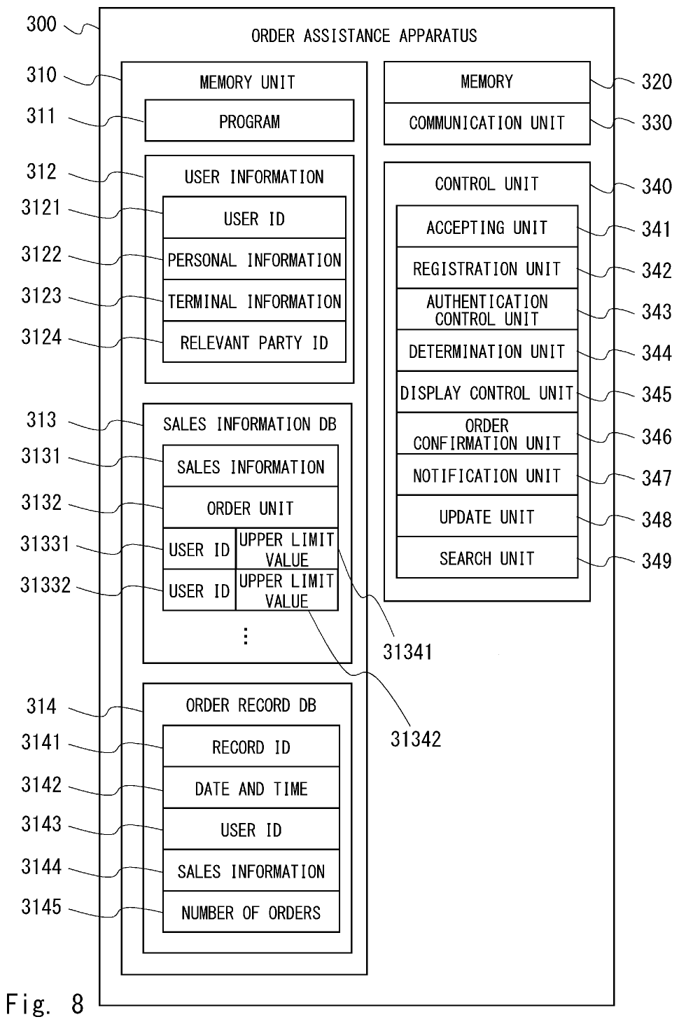

FIG. 8 is a block diagram illustrating a configuration of the order assistance apparatus 300 according to the second example embodiment. The order assistance apparatus 300 includes a memory unit 310, a memory 320, a communication unit 330, and a control unit 340. The memory unit 310 is one example of a storage apparatus such as a hard disk, flash memory, SSD, and the like. The memory unit 310 stores a program 311, user information 312, sales information DB 313, and an order record DB 314. The program 311 is a computer program in which processing of the order assistance method according to the second example embodiment is implemented, and is one example of the order assistance program.

The user information 312 is information for managing users of the order assistance system 1000. The user information 312 is information that corresponds, for each record, a user ID 3121, personal information 3122, terminal information 3123, and relevant party ID 3124 to each other. The user ID 3121 is a user's identification information. The user ID 3121 is information which is the same as or uniquely corresponds to the user ID 211 managed associated with the facial feature information 212 within the facial information DB 210 of the authentication apparatus 200. Therefore, the user information 312 can be said to be information in correspondence with the identity authentication information via the user ID 3121 for registering users.

The personal information 3122 includes the user's name, gender, date of birth, address, nationality, contact information, and payment information, and the like. However, the personal information 3122 is not limited thereto.

The terminal information 3123 is information that serves as the destination for notifications to the user terminal 100 owned by the user. The terminal information 3123 can be, for example, a mobile phone number, e-mail address, application user ID, social network service account, and the like.

The relevant party ID 3124 is a user ID of the relevant party for a direct user of the order screen. The relevant party is those who receives information regarding user's order, or those whose consent must be requested when placing orders. For example, when the user ID 3121 is an identification information of the user U1, the relevant party ID 3124 is the identification information of the relevant party U2. Note that the user information 312 does not have to include the relevant party ID 3124.

The sales information DB 313 is a database for managing a plurality of pieces of sales information. The sales information DB 313 is information that corresponds, for each record, sales information 3131 to an order unit 3132. The sales information 3131 includes sales information ID, text information such as descriptive texts for names of items or service being sold, description of contents, and the like, prices (unit price or package deal price), images of the items or services to be sold. Therefore, the sales information 3131 at least includes display information to be displayed as the selection areas in the order screen. In addition, the sales information 3131 may include information relating to available stores for delivery of items (being sold) corresponding to the sales information in question. The information relating to the stores includes addresses of the stores, ranges of the mobile vending vehicles 4 to patrol, as well as the identification information of the stores or mobile vending vehicle 4, or billing information of the payment terminal 400. The available stores for delivery of items being sold shall refer to stores or mobile vending vehicles 4 that handle, will be receiving, or have in stock the item being sold. The order unit 3132 is one example of “the quantity corresponding to one selecting operation” for an item being sold or the like. For example, the order unit 3132 may be “1” when items are sold as single items, numerical values equal to or greater than “2” in the case of packaged items. The packaged items are items for bulk orders, for example, sets of 6 pieces of certain items.

Furthermore, the sales information DB 313 is information that includes records, each including one sales information 3131 associated with one or more combinations of user ID and upper limit value. For example, a specific sales information 3131 may be associated with a combination of user ID 31331 and upper limit value 31341, a combination of user ID 31332 and upper limit value 31342, and so forth. The user ID 31331 and the like are information corresponding to the above-described user ID 3121. The upper limit value 31341 and the like represent the upper limit value for the number of orders of items being sold or the like within a single order confirmation processing (order confirming operation). In other words, the upper limit value can be set to different values for different users for the same sales information. Also, the upper limit value can be set to different values depending on the type of sales information. For example, the upper limit value for fresh food may be relatively low and the upper limit value for drinking water may be relatively high. The upper limit value may also be set to different values depending on the unit price of the sales information.

The order record DB 314 is a database for recording order records for each user. The order record DB 314 is information that corresponds, for each record, a record ID 3141, date and time 3142, user ID 3143, sales information 3144, and number of orders 3145 to each other. The record ID 3141 is the per-order records identification information. The date and time 3142 is the date and time the order confirmation processing was executed. The user ID 3143 is the user ID of the user who placed the order (order confirming operation). The user ID 3143 is information corresponding to the above-described user ID 3121. The sales information 3144 includes at least the ordered sales information ID and is information that can identify the sales information 3131 described above. The number of orders 3145 is the number of items being sold ordered for the sales information 3144 in a single order records. Note that the number of orders 3145 is in one-to-one correspondence to the sales information 3144. Note that one order records may include a plurality of types of sales information. In this case, one record ID 3141 is associated with two or more combinations of sales information 3144 and number of orders 3145.

The memory 320 is a volatile storage apparatus such as Random Access Memory (RAM) and the like, which is a storage area for temporarily retaining information when the control unit 340 is operating. The communication unit 330 is a communication interface with the network N.

The control unit 340 is a processor, that is, a controller, configured to control each component of the order assistance apparatus 300. The control unit 340 reads the program 311 from the memory unit 310 to the memory 320 and executes the program 311. Accordingly, the control unit 340 implements functions of an accepting unit 341, a registration unit 342, an authentication control unit 343, a determination unit 344, a display control unit 345, an order confirmation unit 346, a notification unit 347, an update unit 348 and a search unit 349.

The accepting unit 341 accepts an input operation by users from the user terminal 100 via a network N. For example, the accepting unit 341 accepts selecting operations, page switching operations on the order screen, an order confirming operation for selected sales information and number of orders, a purchase termination operation, and the like for sales information. The accepting unit 341 then accepts a voice data of the user U1 from the user terminal 100-1 via a network N. The accepting unit 341 accepts the consent or disagreement of the user U1 to (search) keywords extracted (from voice data) from the user terminal 100-1 via the network N. The accepting unit 341 accepts the consent or disagreement of the relevant party U2 regarding the order contents (sales information and number of orders) of user U1 from user terminal 100-2 via the network N.

The registration unit 342 performs user registration processing. In other words, the registration unit 342 generates user information 312 based on the received user information registration request and registers it in the memory unit 310. Specifically, the registration unit 342 acquires facial images from the user information registration request received from the user terminal 100 and transmits facial information registration request including the facial images in question to the authentication apparatus 200. The registration unit 342 acquires the user ID issued in response to the registration of facial information from the authentication apparatus 200. Alternatively, when the authentication apparatus 200 is not used in identity authentication processing, the registration unit 342 may issue a new user ID. The registration unit 342 generates user information 312 by associating the issued user ID 3121, the personal information 3122 included in the registration request, the terminal information 3123 of the user terminal 100, and the relevant party ID 3124. Since the user ID corresponds to facial feature information as described above, it can be said that the registration unit 342 registers the identity authentication information for registering the user associated with the personal information in advance as the user information.

After the order confirmation processing, the registration unit 342 registers the sales information for which the order have been confirmed and the number of orders thereof in association with the user who placed the order and the date and time of the order in the memory unit 310 as an order record. In other words, when an order confirming operation for sales information by a given user is accepted, the registration unit 342 registers the number of orders in the sales information in question as an order record in correspondence to the user in question and the sales information in question. Therefore, the registration unit 342 may be referred to as a record registration means.

When the information received from the user terminal 100 includes the user's identity authentication information, the authentication control unit 343 controls the identity authentication processing for the identity authentication information in question. For example, when the received order screen display request includes facial images of user U1, the authentication control unit 343 controls facial authentication for the facial images. Specifically, the authentication control unit 343 transmits a facial authentication request including facial images to the authentication apparatus 200 and receives facial authentication results from the authentication apparatus 200. The authentication control unit 343 determines the success or failure of the authentication from the facial authentication results received from the authentication apparatus 200 and, when the authentication is successful, identifies the user ID included in the facial authentication results. Note that the authentication control unit 343 may also detect the user's facial areas from the facial images and include the image of the facial areas in the facial authentication request. Alternatively, the authentication control unit 343 may extract facial feature information from the facial areas and include the facial feature information in the facial authentication request.

However, as described above, identity authentication is not limited to facial authentication, and the authentication control unit 343 needs only to be capable of controlling authentication using identity authentication information for registration and authentication. In other words, when the information received from the user terminal 100 includes identity authentication information other than facial images, the authentication control unit 343 performs authentication by controlling matching with the identity authentication information for registration registered in the authentication apparatus or internally, as appropriate, according to the type of identity authentication information. When the authentication is successful, the authentication control unit 343 identifies the corresponding user ID.

When user U1 starts using the user terminal 100-1, the user terminal 100-1 may transmit an identity authentication request including identity authentication information to the order assistance apparatus 300. Then, when the identity authentication by the authentication control unit 343 is successful, the user U1 may be allowed to use the user terminal 100-1. In such a case, when user U1 places an order while using the user terminal 100-1, the user terminal 100-1 may transmit the user ID or the terminal information returned upon successful identity authentication to the order assistance apparatus 300 together with the order screen display request, the selecting operation, the page switching operation, the order confirming operation, and the like. Accordingly, the authentication control unit 343 may control the identity authentication and identify the user ID by the received user ID or terminal information. Alternatively, in addition to the above identity authentication, the identity authentication may be performed at the time of order confirming operation.

The determination unit 344 is one example of determination unit 12 described above. The determination unit 344 judges the type of input operation received by the accepting unit 341. Specifically, the determination unit 344 determines whether the input operation is any of the selecting operation, the page switching operation, the order confirming operation, or a purchase termination operation, or other than these.

In contrast, when the input operation is the selecting operation, the determination unit 344 determines whether or not the number of orders is added to the sales information that has accepted the selecting operation. For example, it is assumed that the number of orders added to each sales information for the user in question during a period from the order screen display request to the order confirming operation or the purchase termination operation is retained in memory unit 310 or the memory 320. In such a case, the determination unit 344 refers to the memory unit 310 or memory 320 and determines that the number of orders has been added based on the fact that the number of orders corresponding to the set of the user in question and the sales information that has accepted the selecting operation is retained. Alternatively, the determination unit 344 may determine whether or not the current number of orders in the sales information is included at the same time with the selecting operation.

Furthermore, when the selecting operation for the sales information displayed with an addition of the number of orders is accepted, the determination unit 344 determines whether or not the number of orders in question is equal to or greater than the upper limit value for the user and the sales information in question.

The display control unit 345 is one example of the above-described display control unit 11. When the number of orders in the sales information that has accepted the selecting operation is smaller than the upper limit value, the display control unit 345 adds the numerical value of the order unit to the number of orders and adds the SELECTED display information and the number of orders after the addition to sales information in question. Since the order unit is not limited to “1” here, two or more of the number of orders may be added by a single selecting operation. The display control unit 345 transmits an instruction for displaying the sales information after the addition of the SELECTED display information and the number of orders to the user terminal 100 via the network N. In other words, the display control unit 345 causes the sales information after the addition of the SELECTED display information and the number of orders to be displayed on the order screen of the user terminal 100. When the number of orders is equal to or greater than 1 and smaller than the upper limit value, the display control unit 345 may transmit an update instruction to the user terminal 100 via the network N for the number of orders after the addition. In this case, since the SELECTED display information has already been added (displayed) to the sales information in question, the communication load and processing load can be reduced.

When the number of orders of the sales information that has accepted the selecting operation is equal to or greater than the upper limit value, the display control unit 345 deletes the display of the number of orders added to the sales information that has accepted the selecting operation to clear the number of orders in question. Specifically, the display control unit 345 deletes (hides) the display of the SELECTED display information and the number of orders in the sales information that has accepted the selecting operation from the order screen of the user terminal 100. In this case, the display control unit 345 updates the number of orders in the sales information that has accepted the selecting operation to 0. Instead of deleting the number of orders, the display control unit 345 may update the display of the number of orders for the sales information in question on the order screen to 0.

When the display control unit 345 accepts an order screen display request or page switching operation, it acquires one or more sales information of a type according to predetermined rules from the sales information DB 313 and determines display control information including the display order or arrangement of the acquired sales information. At this time, the display control unit 345 may determine display control information corresponding to the user identified by the identity authentication by the authentication control unit 343 described above. The display control unit 345 generates an order screen in which the acquired sales information is arranged based on the display control information, and returns the order screen to the user terminal 100 as the requester for display. In other words, the user terminal 100 in this example embodiment can be used by a plurality of persons, and the order assistance apparatus 300 and authentication apparatus 200 shall perform identity authentication at the start of usage of the user terminal 100 itself or when an order screen display request is made. The display control unit 345 updates the number of orders using the sales information corresponding to the user identified by the identity authentication and the upper limit value thereof. In other words, the upper limit value can be different for each user even for the same sales information.

The display control unit 345 may also determine display control information including at least one of the type, display order or arrangement of the sales information to be displayed on the order screen, according to the order records. Specifically, in response to an order screen display request or page switching operation, the display control unit 345 identifies the order records of the user identified by the identity authentication from the order record DB 314 and determines display control information from the order records in question. The display control unit 345 may display a plurality of pieces of sales information on the order screen based on the display control information in question. This allows the display of sales information optimized for the user's ordering tendencies. In other words, the display control unit 345 may prioritize the display of recommended items and recommended stores for a given user based on order records.

For example, sales information that is frequently ordered by a particular user may be displayed on an initial order screen or at a higher (or left) level. Alternatively, the display control unit 345 may generate a “favorite” category that summarizes the sales information with many order records for a particular user, and display it in the category at the top (or left) of the order screen. Alternatively, the display control unit 345 may display a button in the order screen at all times to display the “favorite” category. These features make it easier for users to perform the selecting operation for the sales information they frequently order without having to perform the page switching operation, thereby improving convenience. In addition, the system can recommend sales information that reflects user's ordering tendencies in real time, which can contribute to improving the number of orders and payment prices.

The display control unit 345 may also generate sales information for bulk orders with a larger order unit for a single selecting operation in the user and sales information combination according to the order records, and display the sales information for bulk orders in question on the order screen. This is because, in order to order many of the same items, the same selecting operation must be performed many times for the same sales information, which is cumbersome. Therefore, by automatically generating and displaying sales information for bulk orders, the user can make bulk purchases while reducing the number of times of performing the selecting operation, thereby improving convenience. For example, suppose that when the display control unit 345 has an item image for ordering PET bottles of water in units of one bottle, a user's order records include a predetermined number or more of instances of PET bottles of water being ordered in bulk, such as six or twelve bottles. In this case, the order assistance apparatus 300 may automatically generate an item image for ordering six PET bottles and an item image for ordering twelve PET bottles of the same water. This allows six bottles of water to be ordered with a single selecting operation. The order assistance apparatus 300 may make the order unit in the sales information for bulk orders larger than the order unit in the original individual sales information. For example, the order assistance apparatus 300 may set the order unit for the PET bottles of water for a bulk orders of six bottles as “6” in contrast to the order unit in the original PET bottle of water being 1 (bottle). Alternatively, the order assistance apparatus 300 may set the order unit in the sales information for bulk orders to 1 and the sales price to a price obtained by multiplying a unit price by the number of bulk orders. For example, when the unit price of the original PET bottle of water is 78 yen, the price of PET bottles of water for a bulk order of six bottles may be 450 yen (discounted price for bulk orders) or 468 yen, and the order unit may be “1”.

When the order confirming operation is accepted, the order confirmation unit 346 performs order confirmation processing at this point based on the selected sales information and the number of orders. In other words, the order confirmation unit 346 performs order placement processing for the number of orders for the sales information being ordered, and gives an instruction to deliver the items to a designated delivery destination. Here, it is assumed that the order confirmation unit 346 collectively performs the order confirmation processing for a selected plurality of types of sales information. At this time, the order confirmation unit 346 performs the payment processing using the payment information included in the user's personal information. The order confirmation unit 346 may perform the order confirmation processing when the identity authentication by the authentication control unit 343 using the identity authentication information included in the order confirming operation is successful. This prevents unauthorized use of payment information. The order confirmation unit 346 may accept an order confirming operation for each sales information, confirm the number of orders for each item each time, and prompt final confirmation of the order contents after the order confirming operation for all items is completed and before proceeding to the payment processing. The order confirmation unit 346 then performs order placement processing described above. These may be called order confirmation processing.

When the order confirming operation is accepted, the order confirmation unit 346 may give an instruction to an available store for delivery of the item corresponding to the sales information in question to place the item on hold. In this case, the order confirmation unit 346 may also be referred to as instruction means. Specifically, the order confirmation unit 346 identifies the store information included in the sales information corresponding to the order confirming operation and gives an instruction to the store information in question to place the item on hold. This allows users to pick up their items placed on hold with a short waiting time when they visit the actual store. Furthermore, when the store information is a mobile vending vehicle 4, the order confirmation unit 346 may transmit an instruction to the payment terminal 400 to place the item on hold. This allows the user to easily receive the placed goods by going to the mobile vending vehicle 4 when it comes near the user's residence or the like.

The notification unit 347 is one example of first notification means, second notification means and output means. When the order confirming operation for sales information by user U1 is accepted, the notification unit 347 may notify the relevant party U2 of the user U1 of an order confirmation request for the sales information in question. In this case, the order confirmation unit 346 performs the order confirmation processing when consent is obtained from the relevant party. This can suppress erroneous operation, unnecessary, or excessive ordering when the ordering user U1 is the person to be monitored by the relevant party U2. It also makes it easier for relevant party U2 to grasp the order status of user U1, the person to be monitored, in real time. Each time the order confirming operation is performed for each sales information, the order confirmation unit 346 may confirm the number of orders for the sales information in question, and the notification unit 347 may notify the relevant party of an order confirmation request of the sales information in question for each sales information. Alternatively, the order confirmation unit 346 may notify the relevant party of an order confirmation request regarding the order contents after the order confirming operation in all sales information has been completed and before proceeding to the payment processing.

Furthermore, the notification unit 347 may notify an order confirmation request when the order amount in the order confirming operation is equal to or greater than a predetermined amount. This allows relevant party U2 to suppress user U1 from placing excessive orders and to reduce the frequency of confirmations to relevant party U2, thereby achieving moderate monitoring of user U1's purchasing behavior.

When voice data is acquired from the user U1, the notification unit 347 extracts keywords included in the voice data in question and outputs voice data corresponding to the extracted keywords to the user U1. In this case, when consent for a keyword is accepted from the user U1, the display control unit 345 displays the results of the search process for sales information using the keywords in question by the search unit 349 on the screen of the user terminal 100-1. This allows user U1 to easily search for sales information, improving ordering convenience.

The update unit 348 performs the upper limit value update processing. The update unit 348 updates the upper limit value for the number of orders in the sales information for a particular user according to the order records of the user in question. This allows the upper limit value to be adjusted flexibly, taking into account user's ordering tendencies. Specifically, the update unit 348 may update the upper limit value to a higher value when the order records with the number of orders at the upper limit value is reached a predetermined number. For example, when the user U1 orders a particular item up to the upper limit value of “2” five or more times, the upper limit value may be raised to “5”. Likewise, it is assumed that there is an item image (sales information) for ordering PET bottles of water in units of one bottle, that the upper limit value for ordering PET bottles of water for a particular user is six bottles, and that the user's order records in question includes a predetermined number or more of records in which the number of orders of PET bottles of water is six bottles. In this case, the update unit 348 may update the upper limit value for the user in question and the item in question to a value higher than six. At this time, the order assistance apparatus 300 may also generate an item image for ordering six PET bottles of the same water, as described above. The order assistance apparatus 300 may display an item image in units of one PET bottle of water and the item image in units of six bottles generated above on the order screen of the particular user. In addition, in the above, the upper limit value may be updated to twelve or more in the case of “twelve bottles” separately from “six bottles”, and the item images in units of twelve bottles may be generated and displayed in the same way. The update unit 348 may update the upper limit value to a different value for each item based on the order records. For example, the upper limit value for an item A may remain at 2, while the upper limit value for an item B may be updated by increasing the number of items from two to six.

Furthermore, when the upper limit value is updated, the notification unit 347 may notify the user U1 or relevant party U2 of the upper limit value after update. This makes it easier for user U1 himself to order the particular item in bulk, reducing the number of times of order and improving convenience. It also makes it easier for relevant party U2 to grasp the user U1's ordering tendencies. In addition, the notification unit 347 may give an advance notification to the user U1 or the relevant party U2 before update of the fact that the update unit 348 will update the upper limit value. In this case, the update unit 348 updates the upper limit value after receiving approval for the advance notification. Furthermore, the notification unit 347 can notify the user U1 accordingly when sales information for bulk orders is generated as described above. In other words, the notification unit 347 may recommend the generated sales information for bulk orders to user U1. At this time, the notification unit 347 may give an advance notification to the user U1 or the relevant party U2 of the fact that the display control unit 345 generates sales information for bulk orders. Then, after receiving approval for the advance notification, the display control unit 345 generates sales information for bulk orders.

The search unit 349 performs the keyword search processing. When the user U1 agrees to the extracted keywords described above, the search unit 349 searches the sales information DB 313 using the keywords in question, and makes a list of applicable sales information as a search result.

In addition, the order assistance apparatus 300 may count the number of times the number of orders has been cleared (clear count) and record the clear count by the user in sales information associated with the user ID in the sales information DB 313 or the order record DB 314. The order assistance apparatus 300 may refer to the record DB in question, and when the number of clear count exceeds a predetermined number of times, may notify the relevant party of the user in question accordingly. In other words, the relevant party may be notified when orders (selecting operations) that exceed the upper limit values, that is, automatic cancellation of orders, occurs frequently. This allows the relevant party to recognize the need to review the upper limit values and the possibility of a decline in the user's ability to operate the system.

The following is an example of the use of the order assistance system 1000. First, it is assumed that the user U1 and the relevant party U2 have pre-registered their user information as described above. The user U1 operates the user terminal 100-1 to display the order screen. For example, the user terminal 100-1 captures the user U1's face and transmits an identity authentication request including the facial images to order assistance apparatus 300 via the network N. When the identity authentication is successful at the order assistance apparatus 300, the user terminal 100-1 receives the user ID of the user U1 from the order assistance apparatus 300 and retains it in the memory unit 150 or the memory 170. The user terminal 100-1 displays various menus including “shopping” and accepts the selecting operation of “shopping” from the user U1. In response, the user terminal 100-1 transmits an order screen display request including the user ID or the terminal information to the order assistance apparatus 300 via the network N. Alternatively, the user terminal 100-1 may transmit an order screen display request including facial images to the order assistance apparatus 300 via the network N. In response, the display control unit 345 of the order assistance apparatus 300 generates an order screen corresponding to the user U1 and returns the order screen to the user terminal 100-1 via the network N, as described above. The user terminal 100-1 displays the received order screen.

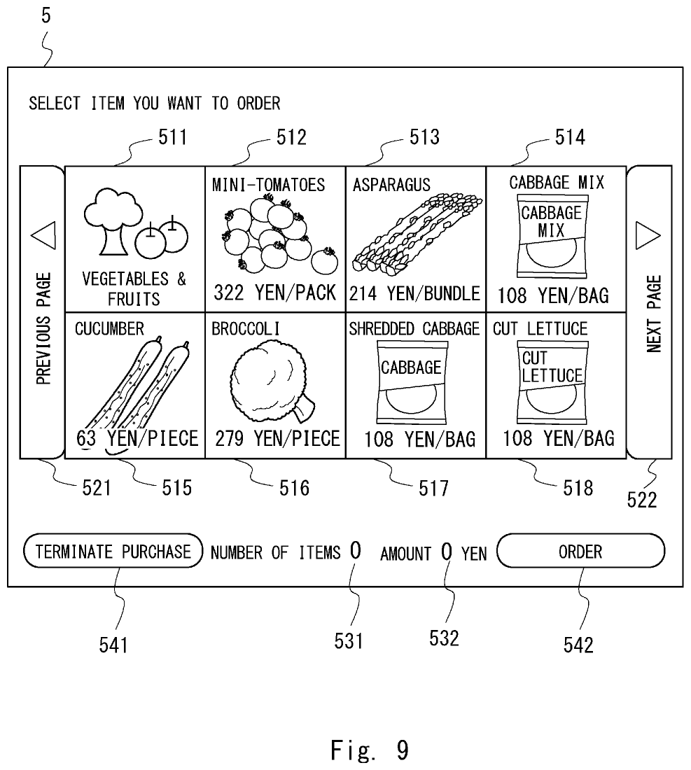

FIG. 9 is a drawing illustrating an example of an order screen 5 according to the second example embodiment. The order screen 5 is an item selection screen for selecting items, that is, sales information, and confirming orders. In other words, the order screen 5 displays a plurality of types of sales information and displays the number of orders for each item separately, while also displaying the total quantity and the total amount. The order screen 5 includes an item category 511, sales information 512 to 518, page switching buttons 521 and 522, a total quantity 531, a total amount 532, a purchase termination button 541, and an order confirmation button 542. The item category 511 is information indicating the category of the items that covers the sales information 512 to 518. The item category 511 is an example showing a category “fruits and vegetables”.

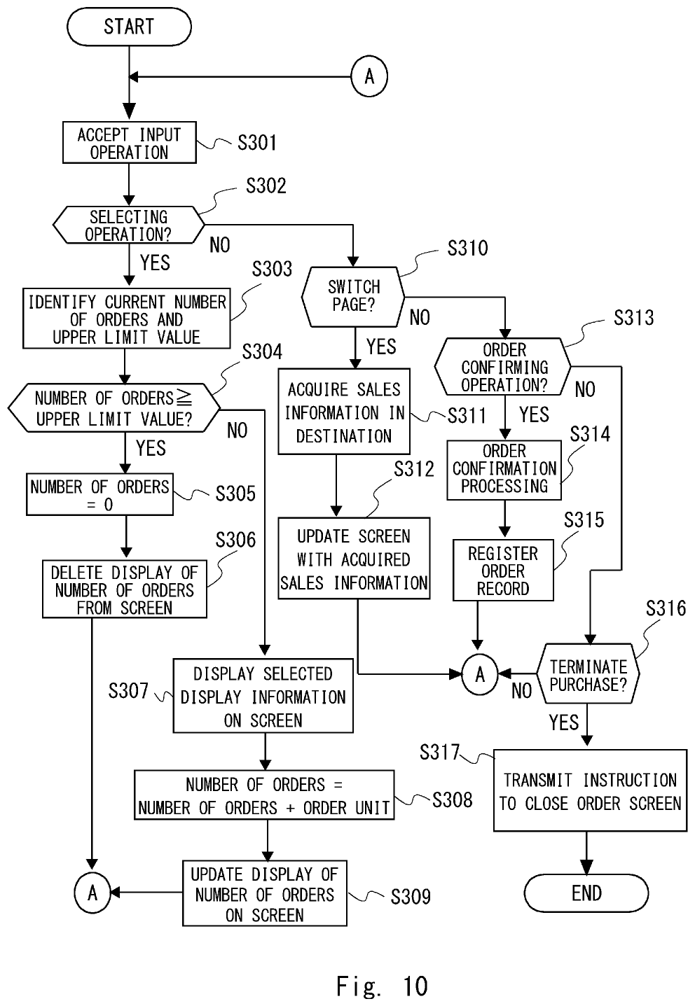

The sales information 512 to 518 are a display and selection areas for item information being sold. The sales information 512 and the like represents images showing the item image, the order unit, and the unit price (per order unit). The sales information 512 is an example showing that a pack of mini-tomatoes costs 322 yen. The sales information 513 is an example showing that a bundle of asparagus costs 214 yen. The sales information 514 is an example showing that a bag of cabbage mix costs 108 yen. The sales information 515 is an example showing that one cucumber costs 63 yen. The sales information 516 is an example showing that one piece of broccoli costs 279 yen. The sales information 517 is an example showing that a bag of shredded cabbage costs 108 yen. The sales information 518 is an example showing that a bag of cut lettuce costs 108 yen. Note that the item categories and sales information in FIG. 10 are merely examples and are not limited thereto. Upon acceptance of the selecting operation for the sales information 512 or the like, the user terminal 100-1 transmits a notification indicating that a selecting operation has been performed for the corresponding sales information, including the sales information of the corresponding selection area and the user ID or the terminal information to order assistance apparatus 300.

The page switching button 521 is an area for accepting switching operations to switch to the previous page. The page switching button 522 is an area for accepting page switching operations to switch to the next page. When the page switching button 521 or 522 is pressed, the user terminal 100-1 transmits to the order assistance apparatus 300 that the previous or next page switching operation was performed, including the current page contents (or page ID) (including the user ID or the terminal information).

The total quantity 531 is a column that displays the total quantity of selected items at that point, including other pages. The total quantity is, for example, the sum of the number of orders per sales information. The total amount 532 is a column that displays the total amount of selected items including other pages. The total amount 532 is the sum of the unit price (or package deal price) for each sales information multiplied by the number of orders. The purchase termination button 541 is an area for accepting purchase termination operations. When the purchase termination button 541 is pressed, the user terminal 100-1 transmits a notification indicating that the purchase termination operation has been performed (including user ID or terminal information) to the order assistance apparatus 300. The order confirmation button 542 is an area for accepting order confirming operations. When the order confirmation button 542 is pressed, the user terminal 100-1 transmits a notification indicating that the order confirming operation has been performed, including the sales information that has been selected on each page (including the user ID or terminal information), the number of orders, and the total amount 532 to the order assistance apparatus 300. At the same time, the user terminal 100-1 may transmit the identity authentication information of the user U1 or the terminal information of the user terminal 100-1. In FIG. 9, the sales information 513 is placed to the right of sales information 512, but as described above, at least one of the type, display order, or arrangement of the sales information to be displayed on the order screen may be changed according to the order records. For example, the order screen 5 may display items with more order records at the top (the left) and items with less order records at the bottom (the right).

Since general e-commerce screens often display specific item information by following hierarchically structured categories, they are insufficiently convenient for the elderly and the like. In contrast, in order to reduce confusion for the user U1, such as the elderly, when selecting an item, the order screen in this example embodiment imitates a paper flyer and displays categories related to the items currently displayed on the screen along with item images to be selected. This makes it easy for the user to know whether the item group currently displayed on the screen is vegetables or fruits. Therefore, the order screen in this example embodiment has the effect of enabling intuitive operation by users such as the elderly or the like.

FIG. 10 is a flowchart showing a flow of an order assistance processing according to the second example embodiment. First, the accepting unit 341 accepts an input operation from the user terminal 100-1 via a network N (S301). Next, the determination unit 344 determines whether or not the input operation is a selecting operation (S302).

When the input operation is not a selecting operation (NO in Step S302), the determination unit 344 determines whether or not the input operation is a page switching operation (S310). When the input operation is a page switching operation (YES in Step S310), the display control unit 345 identifies whether the page switching operation is the previous or the next. The display control unit 345 also identifies the user ID, current page contents, and the like included in the notification that the page switching operation has been performed. Then, the display control unit 345 acquires the sales information from the sales information DB 313 as the previous or next page contents for the switching destination based on the current page content (S312). For example, if there is other sales information belonging to the same item category as the current page content, the display control unit 345 acquires the corresponding sales information. Alternatively, the display control unit 345 may acquire sales information belonging to a different item categories from the current page contents. The display control unit 345 may also identify the order records associated with the identified user ID from the order record DB 314 and acquire sales information based on the order record in question. The display control unit 345 generates an order screen including the list of acquired sales information, and transmits the order screen in question to the user terminal 100-1 via the network N. In other words, the display control unit 345 transmits an instruction to update the order screen with the acquired sales information (S313). The user terminal 100-1 updates the display contents on the order screen according to the received instruction.

The display control unit 345 may also determine display control information based on the order records as described above. The display control unit 345 may generate an order screen in which the acquired sales information is arranged based on the display control information. For example, the display control unit 345 may preferentially acquire the sales information that is ordered more frequently by user U1 and generate an order screen with the higher priority sales information placed higher (e.g., starting from the upper left of the screen).

After Step S313, the procedure goes back to Step S301.

When the input operation is a selecting operation (YES in Step S302), the display control unit 345 identifies the current number of orders and the upper limit value in the sales information that has accepted the selecting operation (S303). Specifically, the display control unit 345 identifies the sales information, the number of orders, and the user ID included in the notification indicating that the selecting operation was performed. When the number of orders is not included, the display control unit 345 identifies 0 as the number of orders. Alternatively, when the number of orders for each sales information and user ID combination is maintained in the memory 320, the display control unit 345 may refer to the memory 320 to identify the current number of orders. The display control unit 345 identifies the upper limit value 31341 associated with the identified sales information 3131 and user ID 31331 from the sales information DB 313.

The determination unit 344 then determines whether or not the identified number of orders is equal to or greater than the identified upper limit value (S304). When the number of orders is smaller than the upper limit value (NO in Step S304), the display control unit 345 updates the order screen with the addition of the SELECTED display information to the sales information that has accepted the selecting operation (S307). Specifically, the display control unit 345 transmits instructions to the order assistance apparatus 300 via the network N to add the SELECTED display information to the images of the sales information that has accepted the selecting operation. When the number of orders at the time of the selecting operation is one or more, and therefore the “SELECTED display information” is already displayed, Step S307 may be omitted.

The display control unit 345 identifies the order unit 3132 in correspondence to the sales information 3131 identified above from the sales information DB 313. The display control unit 345 adds the order unit to the identified number of orders (S308). The display control unit 345 updates the display of the number of orders on the order screen (S309). Specifically, the display control unit 345 transmits instructions to the order assistance apparatus 300 via the network N to add the number of orders after the addition to the sales information that has accepted the selecting operation. In response, the user terminal 100-1 displays “SELECTED display information” and “number of orders after the addition” in the sales information that has accepted the selecting operation on the order screen. Note that Steps S307 and S308 may be performed together.

At the same time, the display control unit 345 updates the total quantity and total amount of the currently selected items and transmits the instructions for updating the total quantity and total amount to the order assistance apparatus 300 via the network N. For example, the accepting unit 341 shall receive the total quantity 531 and the total amount 532, along with the notification indicating that a selecting operation was performed. The display control unit 345 adds the order unit identified above to the total quantity accepted. The display control unit 345 calculates an amount obtained by multiplying the unit price (or package deal price) of the identified sales information by the order unit, and adds the calculated amount to the accepted total amount. Alternatively, the display control unit 345 may recalculate the total amount based on the unit price and number of orders for the previously selected sales information. Other general methods can be used to calculate the total quantity and total amount.

Then, the procedure goes back to Step S301.

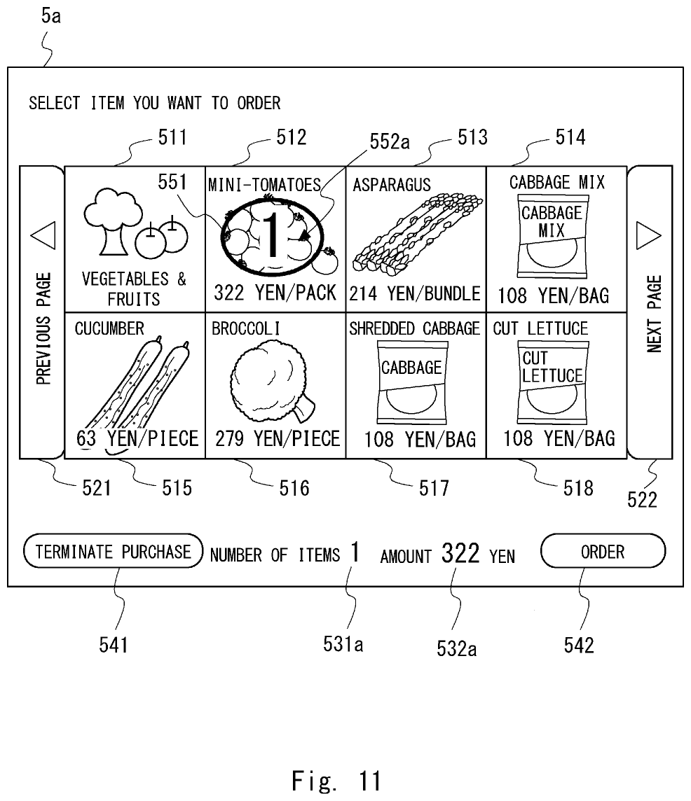

FIG. 11 is a drawing illustrating an example showing a state in which an item has been selected according to the second example embodiment. The order screen 5a shows the state of the order screen 5 in FIG. 9 described above, where the screen has been updated by the user U1 having performed the selecting operation on the sales information 512. The upper limit value in the sales information 512 and user U1 combination shall be “2”. Since the number of orders in the sales information 512 is “0” (hidden) at the time when the order screen 5 is shown, the upper limit value is determined to be smaller than “2” (NO in Step S304). Therefore, in the order screen 5a, in contrast to the order screen 5, SELECTED display information 551 and the number of orders 552a are additionally displayed on the sales information 512, and the total quantity 531a and the total amount 532a are updated.

Here, the SELECTED display information 551 should be an easily visible indication to the user that the corresponding sales information has been selected by the user. For example, the SELECTED display information 551 may be a red circle, but is not limited thereto. Additionally, the number of orders 552a indicates that an item in the sales information has been selected as one piece (one pack). The total quantity 531a indicates that “1” was added to “0” of the total quantity 531 in FIG. 9, resulting in a display of “1”. Furthermore, the total amount 532a indicates that the price of 322 yen, which is a price of one batch (one pack) of mini-tomatoes, was added to “0 yen” for the total amount 532 in FIG. 9, resulting in a display of “322 yen”.

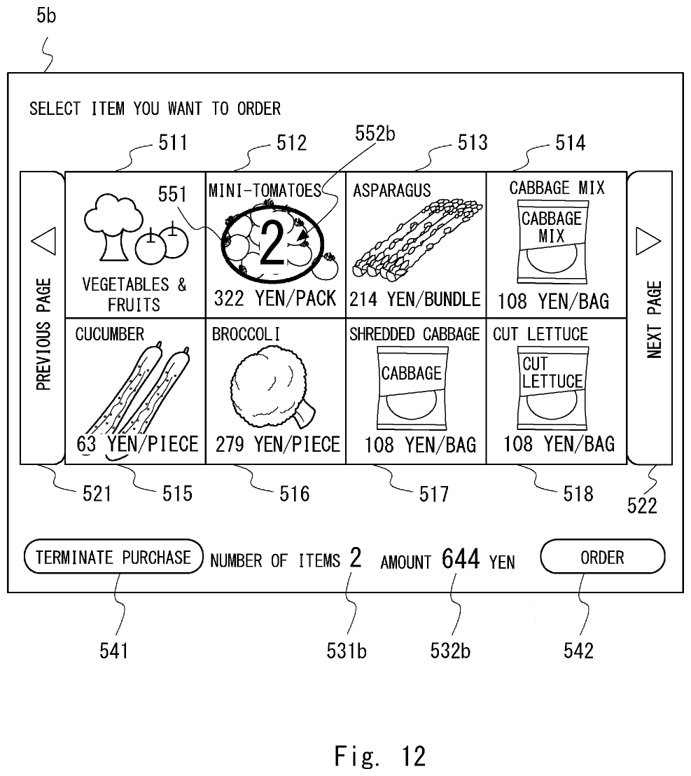

FIG. 12 is a drawing illustrating an example showing a state in which an item has been selected to the upper limit value according to the second example embodiment. The order screen 5b illustrates a state in which the order screen 5a in FIG. 11 described above was updated by the user U1 having performed the selecting operation again for the sales information 512. In other words, it indicates that a selecting operation has been performed for the sales information 512 displayed with an addition of the SELECTED display information 551 and the number of orders 552a. Since the number of orders in the sales information 512 is “1” at the time when the order screen 5a is shown, the upper limit value is determined to be smaller than “2” (NO in Step S304). Therefore, in contrast to the order screen 5a, in the order screen 5b, a number of orders 552b, a total quantity 531b, and a total amount 532b are updated. In other words, the display of the SELECTED display information 551 added to the sales information 512 is maintained (or updated to the same display). The number of orders 552b indicates that 1 is added to the “1” in the number of orders 552a in FIG. 11, resulting in a display of “2”. The total amount 532b indicates that 322 yen, the price of one batch (one pack) of mini-tomatoes, was added to “322 yen” as the total amount 532a in FIG. 11, resulting in a display of “644 yen”.

In this manner, on the order screens 5a and 5b, a red circle indicating that the item has been selected and the number of items are displayed on the item image (sales information). Therefore, users can easily identify the items being ordered and the number of orders.

Referring back to FIG. 10, description will be continued.

When the number of orders is equal to or greater than the upper limit value (YES in Step S304), the display control unit 345 assigns 0 to the number of orders (S305). For example, the display control unit 345 registers (updates) the combination of sales information and user ID associated with the number of orders in the memory 320. The display control unit 345 removes the display of the number of orders from the order screen (S306). Specifically, the display control unit 345 transmits instructions to delete displays of the SELECTED display information and the number of orders for the sales information that has accepted the selecting operation to the order assistance apparatus 300 via the network N.

At the same time, the display control unit 345 updates the total quantity and total amount of the currently selected items to “0” and transmits the instructions for updating the total quantity and total amount to the order assistance apparatus 300 via the network N. In other words, when the number of orders is equal to or greater than the upper limit value, the screen display is updated assuming that the order for the corresponding sales information has been canceled.

Then, the procedure goes back to Step S301.

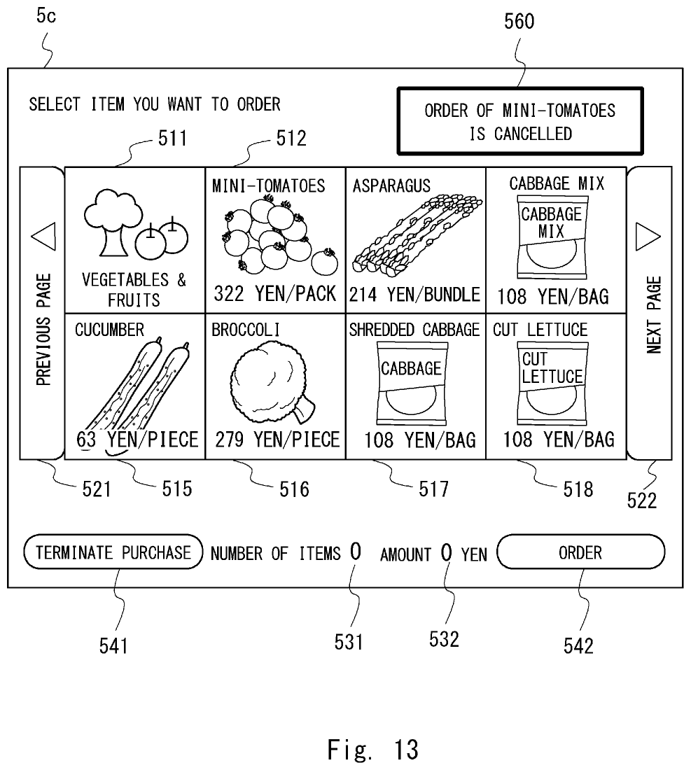

FIG. 13 is a drawing of an example illustrating a state in which the selection of the item is canceled according to the second example embodiment. The order screen 5c illustrates a state in which the order screen 5b in FIG. 12 described above was updated by the user U1 having performed the selecting operation again for the sales information 512. In other words, it indicates that a selecting operation has been performed for the sales information 512 displayed with an addition of the SELECTED display information 551 and the number of orders 552b. Since the number of orders in the sales information 512 is “2” at the time when the order screen 5b is shown, the upper limit value is determined to be equal to or greater than “2” (YES in Step S304). Therefore, in the order screen 5c, in contrast to the order screen 5b, displays of the SELECTED display information 551 and the number of orders 552b are deleted, and the total quantity 531 and the total amount 532 are updated to “0”. In addition, the order screen 5c may display a cancellation indicator 560. The cancellation indicator 560 is a message indicating that the order for the selected item has been canceled in response to the selecting operation. The cancellation indicator 560 is an example of a message “The order of mini-tomatoes has been canceled”, but is not limited thereto. The cancellation indicator 560 may also display the reason of the cancellation. For example, the cancellation indicator 560 may display a message such as “the order of mini-tomatoes has been canceled because the number of orders exceeds the upper limit value”. Note that the cancellation indicator 560 is not required.

In this manner, although the number of orders increases each time the item image (the selection area of the sales information) is pressed, the number of orders is canceled when the number of times of the same pressing operation for the same item image reaches a certain value. Such an operation system can suppress the elderly from unintentionally making a large number of purchases or not knowing how to cancel a purchase.

Referring back to FIG. 10, description will be continued.

When the input operation is not the page switching operation (NO in Step S310), the determination unit 344 determines whether or not the input operation is an order confirming operation (S313). When the input operation is the order confirming operation (YES in Step S313), the order confirmation unit 346 performs the order confirmation processing described above (S314). For example, when user U1 presses the order confirmation button 542 in the state of order screen 5b in FIG. 12 above, the order confirmation unit 346 performs the order confirmation processing, assuming that two packages of mini-tomatoes have been ordered.

After Step S315, the registration unit 342 issues a new record ID and generates an order records by associating the issued record ID 3141, the user ID 3143 of user U1, the date and time when the order was confirmed 3142, the sales information 3144, and the number of orders 3145. The registration unit 342 registers the generated order record in the order record DB 314 (S315). This allows the order screen to be generated and displayed in the future according to the type, arrangement, and display order of sales information, taking into account the order record of user U1.

Then, the procedure goes back to Step S301.

When the input operation is not the order confirming operation (NO in Step S313), the determination unit 344 determines whether or not the input operation is a purchase termination operation (S316). When the input operation is a purchase termination operation (YES in Step S316), the display control unit 345 transmits an instruction to close the order screen to the user terminal 100-1 via the network N (S317). The order assistance apparatus 300 terminates the order assistance processing in question. For example, when user U1 presses the purchase termination button 541 in the state of order screen 5b in FIG. 12 above, user terminal 100-1 closes order screen 5b. In contrast, when the input operation is not the purchase termination operation (NO in Step S316), the procedure goes back to Step S301.

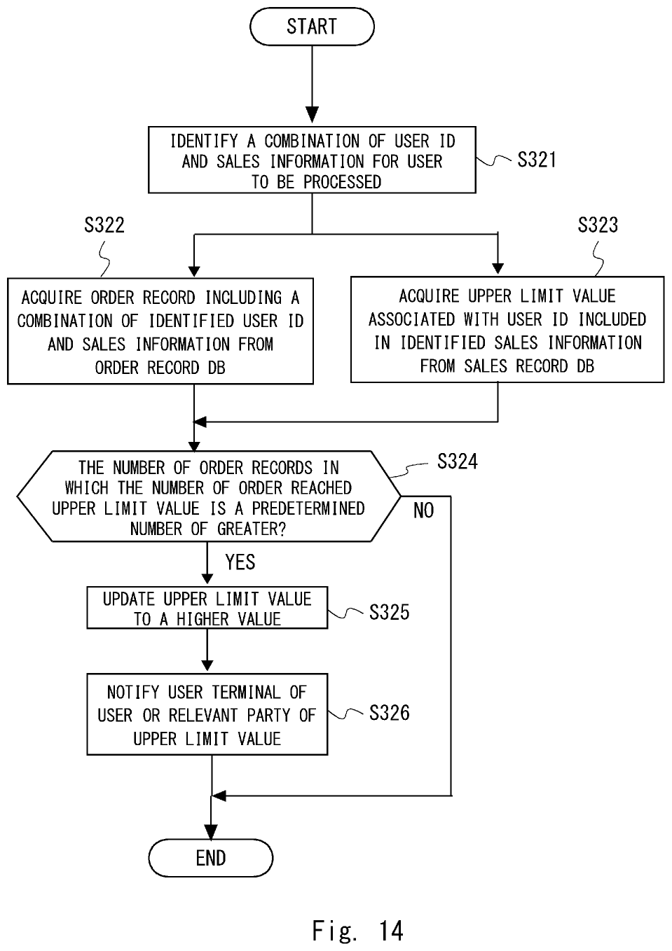

FIG. 14 is a flowchart showing a flow of upper limit value update processing according to the second example embodiment. The update unit 348 initiates the upper limit value update processing periodically or whenever the order record is updated. First, the update unit 348 identifies a combination of the user ID and sales information for the user to be processed (S321). For example, when an order record is registered (updated) in the order record DB 314, the update unit 348 identifies a combination of the user ID 3143 and the sales information 3144 included in the order records in question. Alternatively, the update unit 348 may perform Step S321 and onward sequentially for all the combinations of the user IDs and sales information in the order record DB 314. Here a description will be given assuming that a combination of user U1 and mini-tomatoes is identified.

Next, the update unit 348 acquires an order record from the order record DB 314 that includes the identified combination of user ID 3143 and sales information 3144 (S322). For example, the update unit 348 acquires a record of order of mini-tomatoes in the past by the user U1. At this time, a record containing a plurality of order records may be acquired. The update unit 348 acquires the upper limit value 31341 included in the identified sales information 3131 and associated with the identified user ID 31331 from the sales information DB 313 (S323). For example, the update unit 348 acquires the upper limit value “2” of the user U1 for the mini-tomatoes.

After Steps S322 and S323, the update unit 348 determines whether or not the number of the order records in which the number of orders reaches the upper limit value is equal to or greater than a predetermined number (S324). Specifically, the update unit 348 counts the number of records in the order records acquired in Step S322 for which the number of orders 3145 is the upper limit value of “2”. The update unit 348 determines whether or not the counted number of records is equal to or greater than a predetermined number, for example, “5”. For example, the update unit 348 determines whether or not the user U1 has ordered “2” packs of mini-tomatoes five times or more in the past.

In Step S324, when the number of order records is equal to or greater than a predetermined number, the update unit 348 updates the upper limit value to a higher value (S325). For example, the update unit 348 changes the upper limit value “2” of the user U1 for the mini-tomatoes to “5” to update the upper limit value 31341 of the sales information DB 313. The notification unit 347 notifies the user terminal 100 of the identified user or relevant party of the updated upper limit value (S326). Specifically, the notification unit 347 identifies the terminal information 3123 associated with the identified user ID 3121 from the user information 312. For example, the notification unit 347 identifies the terminal information of the user terminal 100-1 of the user U1 and transmits the notification indicating that the upper limit value in mini-tomatoes has been updated to “5” to user terminal 100-1 via the network N. Alternatively, the notification unit 347 identifies the relevant party ID 3124 associated with the identified user ID 3121, and identifies the terminal information 3123 associated with the user ID 3121, which is the identified relevant party ID, from the user information 312. For example, the notification unit 347 identifies the terminal information of user terminal 100-2 of the relevant party U2 of the user U1 from the user information 312. The notification unit 347 transmits the notification indicating that the upper limit value in mini-tomatoes for the user U1 has been updated to “5” to user terminal 100-2 via the network N. For example, the user terminal 100 may display a pop-up in response to notification of the updated upper limit value. This allows the user or relevant party to know the updated upper limit value more quickly.

When the number of order records is less than the predetermined number in Step S324, or after Step S326, the upper limit value update processing is terminated. Note that, after these steps, the procedure may return to Step S321 to identify other user and sales information combinations and perform the upper limit value update processing.

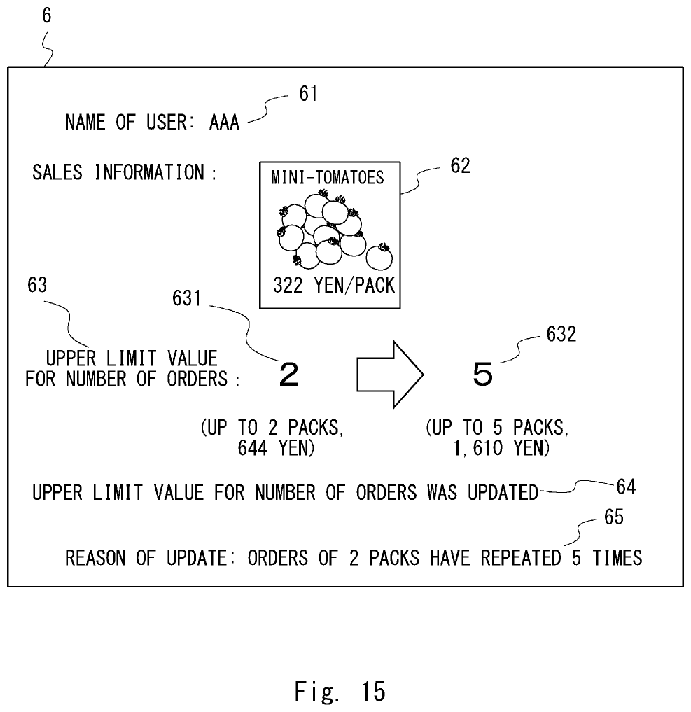

FIG. 15 is a drawing illustrating an example of an upper limit value update notification screen 6 according to the second example embodiment. The upper limit value update notification screen 6 is one example of a screen displayed in response to the user terminal 100 receiving the notification according to Step S326. The upper limit value update notification screen 6 includes a target user 61, a target sales information 62, an upper limit value for the number of orders 63, an upper limit value update notification message 64, and a reason of update 65. The target user 61 is a display field for the name of the user whose upper limit value has been updated. The target sales information 62 is a column displaying the sales information with updated upper limit value. The upper limit value for the number of orders 63 is a column indicating before and after the change of the upper limit value for the number of orders in the combination of the target user 61 and target sales information 62, including the upper limit value 631 before update and the upper limit value 632 after update, and the like. The upper limit value 631 before update indicates that the upper limit value for the number of orders in the combination of user AAA and mini-tomatoes was two batches (packs) before update. The upper limit value 632 after update indicates that the upper limit value for the number of orders for the combination of user AAA and mini-tomatoes became five batches (packs) after update. In addition, each of the upper limit value 631 before update and the upper limit value 632 after update may be accompanied by the price at the upper limit value, that is, the upper limit value of the purchase price for the item in question. For example, for the combination of user AAA and mini-tomatoes, it may be indicated that 2 packs, up to 644 yen could be purchased, but now 5 packs, up to 1,610 yen can be purchased. The upper limit value update notification message 64 is an example of text information indicating that the upper limit value for the number of orders has been updated. The reason of update 65 is an example of text information indicating that the reason for updating the upper limit value in question is because of five consecutive orders of two batches (packs). Note that the reason of update 65 is not required.

Here, the upper limit value update notification screen 6 is an after-the-fact notification of the upper limit value update, but the upper limit value update notification screen 6 can be modified to be used for advance notification of the upper limit value update. In such a case, the upper limit value update notification screen 6 shall further display an “Approve” button and a “Disapprove” button. Note that, in this case, the upper limit value update notification message 64 could be something like “Do you want to update the upper limit value for the number of orders from 2 to 5?” When the “Approve” button is pressed, the user terminal 100 transmits a notification indicating approval for the advance notification to the order assistance apparatus 300. When approval for the advance notification is received, the order assistance apparatus 300 updates the upper limit value as described above. In contrast, when the “Disapprove” button is pressed, the user terminal 100 transmits a notification indicating disapproval for the advance notification to the order assistance apparatus 300. When disapproval for the advance notification is received, the order assistance apparatus 300 will not update the upper limit value.

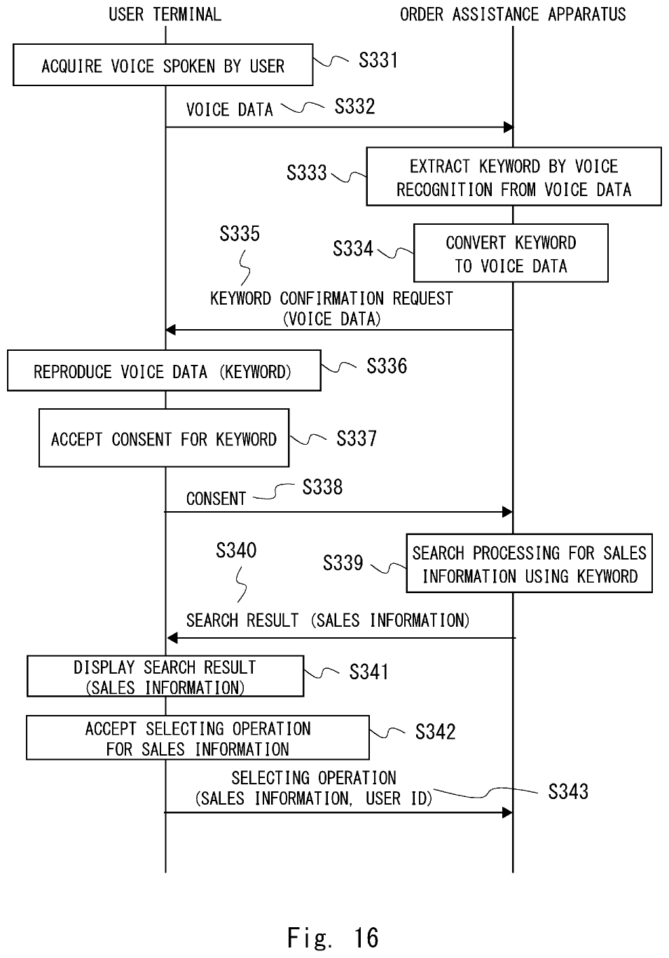

FIG. 16 is a sequence diagram showing a flow of keyword search processing according to the second example embodiment. For example, it is assumed that the user terminal 100-1 has displayed the order screen 5 for the user U1. The user U1 speaks regarding the item he or she is considering purchasing. For example, the user U1 speaks, “I want to buy a kelp rice ball.” In response, the user terminal 100-1 acquires the voice spoken by the user U1 (S331). The user terminal 100-1 transmits the acquired voice data to the order assistance apparatus 300 via the network N (S332).

In response, the notification unit 347 of the order assistance apparatus 300 extracts keywords from the received voice data by voice recognition (S333). In the above example, the notification unit 347 extracts “kelp” and “rice ball” as keywords. The notification unit 347 converts the extracted keywords into voice data (S334). The notification unit 347 transmits a keyword confirmation request, including the converted voice data, to the user terminal 100-1 via the network N (S335).

The user terminal 100-1 reproduces the voice data (keywords) included in the keyword confirmation request received from the order assistance apparatus 300 (S336). For example, the user terminal 100-1 prompts whether or not the extracted keywords are “kelp” and “rice ball” and the user agrees to search for sales information using these keywords. For example, the user terminal 100-1 may confirm the consent to the keywords as a question from the character described above. In other words, the character may recite the keyword part in response to what the user U1, such as an elderly person, has spoken. This allows for a more natural keyword search through conversation between the user and the character. When the user U1 performs the operation to agree, the user terminal 100-1 accepts the consent to the keywords reproduced (S337). For example, the user U1 presses the consent button on the screen or speaks “consent” or the like.

The user terminal 100-1 transmits the consent to the order assistance apparatus 300 via the network N (S338). In response, the search unit 349 of the order assistance apparatus 300 receives the consent and performs search processing for sales information using the keywords extracted in Step S333 (S339). Specifically, the search unit 349 searches for text information in the sales information 3131 of the sales information DB 313 that includes “kelp” and “rice ball”. Here, it is assumed that the search unit 349 has acquired the sales information of “kelp rice balls” as a search result. The display control unit 345 transmits the search results, including sales information, to the user terminal 100-1 via the network N (S340).

In response, the user terminal 100-1 displays the received search results, that is, sales information (S341). Specifically, the user terminal 100-1 displays the sales information for “kelp rice balls” on the order screen. The user U1 performs a selecting operation for the “kelp rice ball” sales information. Therefore, the user terminal 100-1 accepts the selecting operation for the sales information that is the search result (S342). The user terminal 100-1 transmits a notification indicating that a selecting operation has been performed, including the sales information that has accepted the selecting operation and the user ID (or the terminal information) of the user U1 to the order assistance apparatus 300 via the network N (S343).

In response, the order assistance apparatus 300 performs order assistance processing for the sales information that has accepted the selecting operation, as described above. For example, the display control unit 345 displays the sales information “kelp rice ball” with an addition of the SELECTED display information and the number of orders on the order screen of the user terminal 100-1. Thereafter, the user U1 can operate the order screen as described above. Therefore, the user U1 can easily search for desired sales information without repeating the page switching operation or entering search keywords on the screen. This is especially convenient for the elderly who have difficulty operating the screen.

Note that a cab dispatch service may be provided as sales information, although the example of a mobile vending vehicle 4 was given above. In such a case, the order confirmation processing becomes a request for a cab dispatch to a cab near the user's location.

### Other Example Embodiments

In the second example embodiment described above, the order assistance apparatus 300 and the authentication apparatus 200 have been described as separate information processing apparatus, but they may be the same. For example, the order assistance apparatus 300 may register the user ID 3121 of the user information 312 further associated with facial feature information. In that case, the control unit 340 may be equipped with the face detecting unit 220, the feature point extraction unit 230, the registration unit 240, and the authentication unit 250 in FIG. 5.

In the examples above, the program includes a set of instructions (or software codes) that, when read into a computer, causes the computer to execute one or more of the functions described in the example embodiments. The program may be stored in a non-transitory computer-readable medium or a physical storage medium. By way of example, not limitation, the computer-readable medium or the physical storage medium include random-access memory (RAM), read-only memory (ROM), flash memory, solid-state drive (SSD) or other memory technology, CD-ROM, digital versatile disc (DVD), Blu-ray (registered trademark) discs or other optical disc storage, magnetic cassettes, magnetic tape, magnetic disk storage, or other magnetic storage devices. The program may be transmitted on a temporary computer-readable medium or communication medium.

By way of example, not limitation, the temporary computer-readable medium or the communication medium includes electrical, optical, acoustic, or other forms of propagation signals.

The present disclosure is not limited to the example embodiments described above, and may be modified as appropriate without departing from the intent. The present disclosure may also be implemented by combining the respective example embodiments as appropriate.

Some or all of the above example embodiments may also be described as, but not limited to, the following Supplementary note.

### (Supplementary Note A1)

An order assistance apparatus comprising:
display control means configured to display sales information that has accepted a selecting operation from among the plurality of pieces of sales information displayed on a screen with an addition of the number of orders corresponding to the number of times of the selecting operations; and
determining means configured to determine whether or not the number of orders is equal to or greater than an upper limit value when the selecting operation for the sales information displayed with the addition of the number of orders is accepted,
   and in which
the display control means:
updates the display of the number of orders added to the sales information that has accepted the selecting operation by a value obtained by adding the number of orders to a number corresponding to a single selecting operation when the number of orders is smaller than an upper limit value, and
clears the number of orders when the number of orders is equal to or greater than the upper limit value.

### (Supplementary Note A2)

The order assistance apparatus according to Supplementary note A1, in which the display control means:
clears the number of orders by deleting the display of the number of orders added to the sales information that has accepted the selecting operation when the number of orders is equal to or greater than the upper limit value.

### (Supplementary Note A3)

The order assistance apparatus according to Supplementary note A1 or A2, further comprising record registration means configured to,
when an order confirming operation for the sales information by a predetermined user is accepted, registers the number of orders in association with the user and the sales information as an order record.

### (Supplementary Note A4)

The order assistance apparatus according to Supplementary note A3, further comprising update means configured to update the upper limit value for the number of orders in the sales information of the user according to the order record.

### (Supplementary Note A5)

The order assistance apparatus according to Supplementary note A4, in which the update means updates the upper limit value to a higher value when the order records with the number of orders at the upper limit value reaches a predetermined number.

### (Supplementary Note A6)

The order assistance apparatus according to Supplementary note A4 or A5, further comprising first notification means configured to notify the user or a relevant party of the user of an upper limit value after update when the upper limit value is updated.

### (Supplementary Note A7)

The order assistance apparatus according to any one of Supplementary note A3 to A6, in which the display control means generates sales information for bulk orders with a larger order unit for a single selecting operation in the combination of the user and the sales information according to the order records, and displays the sales information for bulk orders on the screen.

### (Supplementary Note A8)

The order assistance apparatus according to any one of Supplementary notes A3 to A7, in which the display control means:
determines display control information including at least one of a type, display order or arrangement of the sales information to be displayed on the screen, according to the order records, and
displays the plurality of pieces of sales information on the screen based on the display control information.

### (Supplementary Note A9)

The order assistance apparatus according to any one of Supplementary notes A1 to A8, in which
the sales information includes information relating to an available store for delivery of an item corresponding to the sales information, and
the order assistance apparatus further comprising instructing means configured to give an instruction to an available store for delivery of the item corresponding to the sales information to place the item on hold when an order confirming operation for the sales information is accepted.

### (Supplementary Note A10)

The order assistance apparatus according to any one of Supplementary notes A1 to A9, further comprising:
output means configured to, when voice data is acquired from a predetermined user, extract a keyword included in the voice data and output voice data corresponding to the extracted keyword to the user, and in which
the display control means:
displays a result of search processing for sales information using a keyword on the screen when consent for the keyword is accepted from the user.

### (Supplementary Note A11)

The order assistance apparatus according to any one of Supplementary notes A1 to A10, further comprising second notification means configured to:
notify, when an order confirming operation for the sales information by a predetermined user is accepted, a relevant party of the user of an order confirmation request for the sales information, and
order confirming means configured to perform order confirmation processing when consent is obtained from the relevant party.

### (Supplementary Note A12)

The order assistance apparatus according to Supplementary note A11, in which the second notification means notifies the order confirmation request when an order amount in the order confirming operation is equal to or greater than a predetermined amount.

### (Supplementary Note B1)

An order assistance system comprising:
a user terminal that displays a plurality of pieces of sales information on a screen and accepts a selecting operation for any of the plurality of sales information from a user; and
an order assistance apparatus connected to the user terminal,
   in which
the order assistance apparatus comprises:
display control means configured to display sales information that has accepted the selecting operation from among the plurality of pieces of sales information displayed on the screen with an addition of the number of orders corresponding to the number of times of the selecting operations;
determining means configured to determine whether or not the number of orders is equal to or greater than an upper limit value when the selecting operation for the sales information displayed with the addition of the number of orders is accepted,
   and in which
the display control means:
updates the display of the number of orders added to the sales information that has accepted the selecting operation by a value obtained by adding the number of orders to a number corresponding to a single selecting operation when the number of orders is smaller than the upper limit value, and
clears the number of orders when the number of orders is equal to or greater than the upper limit value.

### (Supplementary Note B2)

The order assistance system according to Supplementary note B1, in which
the display control means clears the number of orders by deleting the display of the number of orders added to the sales information that has accepted the selecting operation when the number of orders is equal to or greater than the upper limit value.

### (Supplementary Note C1)

An order assistance method, the method causing a computer to:
display sales information that has accepted the selecting operation from among the plurality of pieces of sales information displayed on a screen with an addition of the number of orders corresponding to the number of times of the selecting operations,
determine whether or not the number of orders is equal to or greater than an upper limit value when the selecting operation for the sales information displayed with the addition of the number of orders is accepted,
update the display of the number of orders added to the sales information that has accepted the selecting operation by a value obtained by adding the number of orders to a number corresponding to a single selecting operation when the number of orders is smaller than the upper limit value, and
clear the number of orders when the number of orders is equal to or greater than the upper limit value.

### (Supplementary Note D1)

A non-transitory computer-readable medium storing an order assistance program that causes a computer to execute processing for displaying sales information that has accepted a selecting operation from among the plurality of pieces of sales information displayed on a screen with an addition of the number of orders corresponding to the number of times of the selecting operations;
processing for determining whether or not the number of orders is equal to or greater than an upper limit value when the selecting operation for the sales information displayed with the addition of the number of orders is accepted;
processing for updating a display of the number of orders added to the sales information that has accepted the selecting operation by a value obtained by adding a number corresponding to a single selecting operation to the number of orders when the number of orders is smaller than the upper limit value; and
processing for clearing the number of orders when the number of orders is equal to or greater than the upper limit value.

### REFERENCE SIGNS LIST

1 ORDER ASSISTANCE APPARATUS
11 DISPLAY CONTROL UNIT
12 DETERMINATION UNIT
1000 ORDER ASSISTANCE SYSTEM
N NETWORK
U1 USER
U2 RELEVANT PARTY
U3 STORE STAFF
100 USER TERMINAL
100-1 USER TERMINAL
100-2 USER TERMINAL
110 CAMERA
120 MICROPHONE
130 SPEAKER
140 TOUCH-SENSITIVE PANEL
150 MEMORY UNIT
151 PROGRAM
160 COMMUNICATION UNIT
170 MEMORY
180 CONTROL UNIT
181 REGISTRATION UNIT
182 CONTENT PROCESSING UNIT
200 AUTHENTICATION APPARATUS
210 FACIAL INFORMATION DB
211 USER ID
212 FACIAL FEATURE INFORMATION
220 FACE DETECTING UNIT
230 FEATURE POINT EXTRACTION UNIT
240 REGISTRATION UNIT
250 AUTHENTICATION UNIT
300 ORDER ASSISTANCE APPARATUS
310 MEMORY UNIT
311 PROGRAM
312 USER INFORMATION
3121 USER ID
3122 PERSONAL INFORMATION
3123 TERMINAL INFORMATION
3124 RELEVANT PARTY ID
313 SALES INFORMATION DB
3131 SALES INFORMATION
3132 ORDER UNIT
31331 USER ID
31332 USER ID
31341 UPPER LIMIT VALUE
31342 UPPER LIMIT VALUE
314 ORDER RECORD DB
3141 RECORD ID
3142 DATE AND TIME
3143 USER ID
3144 SALES INFORMATION
3145 NUMBER OF ORDERS
320 MEMORY
330 COMMUNICATION UNIT
340 CONTROL UNIT
341 ACCEPTING UNIT
342 REGISTRATION UNIT
343 AUTHENTICATION CONTROL UNIT
344 DETERMINATION UNIT
345 DISPLAY CONTROL UNIT
346 ORDER CONFIRMATION UNIT
347 NOTIFICATION UNIT
348 UPDATE UNIT
349 SEARCH UNIT
4 MOBILE VENDING VEHICLE
41 ITEMS
400 PAYMENT TERMINAL
5 ORDER SCREEN
5a ORDER SCREEN
5b ORDER SCREEN
5c ORDER SCREEN
511 ITEM CATEGORY
512 SALES INFORMATION
513 SALES INFORMATION
514 SALES INFORMATION
515 SALES INFORMATION
516 SALES INFORMATION
517 SALES INFORMATION
518 SALES INFORMATION
521 PAGE SWITCHING BUTTON
522 PAGE SWITCHING BUTTON
531 TOTAL QUANTITY
532 TOTAL AMOUNT
531a TOTAL QUANTITY
532a TOTAL AMOUNT
531b TOTAL QUANTITY
532b TOTAL AMOUNT
541 PURCHASE TERMINATION BUTTON
542 ORDER CONFIRMATION BUTTON
551 SELECTED DISPLAY INFORMATION
552a NUMBER OF ORDERS
552b NUMBER OF ORDERS
560 CANCELLATION INDICATOR
6 UPPER LIMIT VALUE UPDATE NOTIFICATION SCREEN
61 TARGET USER
62 TARGET SALES INFORMATION
63 UPPER LIMIT VALUE FOR NUMBER OF ORDERS
631 UPPER LIMIT VALUE BEFORE UPDATE
632 UPPER LIMIT VALUE AFTER UPDATE
64 UPPER LIMIT VALUE UPDATE NOTIFICATION MESSAGE
65 REASON OF UPDATE

What is claimed is:

1. An order assistance apparatus comprising:
at least one memory storing instructions; and
at least one processor configured to execute the program instructions stored in the memory to:
display sales information that has accepted a selecting operation from among the plurality of pieces of sales information displayed on a screen with an addition of the number of orders corresponding to the number of times of the selecting operations; and
determine whether or not the number of orders is equal to or greater than an upper limit value when the selecting operation for the sales information displayed with the addition of the number of orders is accepted, wherein
in the displaying of the sales information,
the display of the number of orders added to the sales information that has accepted the selecting operation is updated by a value obtained by adding the number of orders to a number corresponding to a single selecting operation when the number of orders is smaller than an upper limit value, and
the number of orders is cleared when the number of orders is equal to or greater than the upper limit value.

2. The order assistance apparatus according to claim 1, wherein in the displaying of the sales information,
the number of orders is cleared by deleting the display of the number of orders added to the sales information that has accepted the selecting operation when the number of orders is equal to or greater than the upper limit value.

3. The order assistance apparatus according to claim 1, wherein the processor is further configured to execute the program instructions to register, when an order confirming operation for the sales information by a predetermined user is accepted, the number of orders in association with the user and the sales information as an order record.

4. The order assistance apparatus according to claim 3, wherein the processor is further configured to execute the program instructions to update the upper limit value for the number of orders in the sales information of the user according to the order record.

5. The order assistance apparatus according to claim 4, wherein in the updating of the upper limit value, the upper limit value is updated to a higher value when the order records with the number of orders at the upper limit value reaches a predetermined number.

6. The order assistance apparatus according to claim 4, wherein the processor is further configured to execute the program instructions to notify the user or a relevant party of the user of an upper limit value after update when the upper limit value is updated.

7. The order assistance apparatus according to claim 3, wherein in the displaying of the sales information,
sales information for bulk orders with a larger order unit for a single selecting operation in the combination of the user and the sales information is generated according to the order records, and the sales information for bulk orders is displayed on the screen.

8. The order assistance apparatus according to claim 3, wherein in the displaying of the sales information,
display control information including at least one of a type, display order or arrangement of the sales information to be displayed on the screen is determined according to the order records, and
the plurality of pieces of sales information are displayed on the screen based on the display control information.

9. The order assistance apparatus according to claim 1, wherein
the sales information includes information relating to an available store for delivery of an item corresponding to the sales information, and
the processor is further configured to execute the program instructions to give an instruction to an available store for delivery of the item corresponding to the sales information to place the item on hold when an order confirming operation for the sales information is accepted.

10. The order assistance apparatus according to claim 1, wherein
the processor is further configured to execute the program instructions to extract a keyword included in voice data when voice data is acquired from a predetermined user and output voice data corresponding to the extracted keyword to the user, and
in the displaying of the sales information, a result of search processing for sales information using a keyword is displayed on the screen when consent for the keyword is accepted from the user.

11. The order assistance apparatus according to claim 1, wherein
the processor is further configured to execute the program instructions to notify, when an order confirming operation for the sales information by a predetermined user is accepted, a relevant party of the user of an order confirmation request for the sales information, and
perform, when consent is obtained from the relevant party, order confirmation processing.

12. The order assistance apparatus according to claim 11, wherein in the notification of the order confirmation request, the order confirmation request is notified when an order amount in the order confirming operation is equal to or greater than a predetermined amount.

13. An order assistance system comprising:
a user terminal that displays a plurality of pieces of sales information on a screen and accepts a selecting operation for any of the plurality of sales information from a user; and
an order assistance apparatus connected to the user terminal according to claim 1.

14. The order assistance system according to claim 13, wherein
in the displaying of the sales information,
the number of orders is cleared by deleting the display of the number of orders added to the sales information that has accepted the selecting operation when the number of orders is equal to or greater than the upper limit value.

15. An order assistance method, the method causing a computer to:
display sales information that has accepted the selecting operation from among the plurality of pieces of sales information displayed on a screen with an addition of the number of orders corresponding to the number of times of the selecting operations,
determine whether or not the number of orders is equal to or greater than an upper limit value when the selecting operation for the sales information displayed with the addition of the number of orders is accepted,
update the display of the number of orders added to the sales information that has accepted the selecting operation by a value obtained by adding the number of orders to a number corresponding to a single selecting operation when the number of orders is smaller than the upper limit value, and
clear the number of orders when the number of orders is equal to or greater than the upper limit value.

16. A non-transitory computer-readable medium storing an order assistance program that causes a computer to execute:
processing for displaying sales information that has accepted a selecting operation from among the plurality of pieces of sales information displayed on a screen with an addition of the number of orders corresponding to the number of times of the selecting operations;
processing for determining whether or not the number of orders is equal to or greater than an upper limit value when the selecting operation for the sales information displayed with the addition of the number of orders is accepted;
processing for updating a display of the number of orders added to the sales information that has accepted the selecting operation by a value obtained by adding a number corresponding to a single selecting operation to the number of orders when the number of orders is smaller than the upper limit value; and
processing for clearing the number of orders when the number of orders is equal to or greater than the upper limit value.
